(19) United States
(12) Patent Application Publication
(10) Pub. No.: US 2024/0111767 A1
(43) Pub. Date: Apr. 4, 2024

(54) INFRASTRUCTURE FOR GRAPH LINKING

(71) Applicant: Apollo Graph, Inc.

(72) Inventors: Martijn Walraven, Amsterdam (NL); Phil Prasek, Seattle, WA (US); Sylvain Lebresne, Rennes (FR); Frank Peacock, Austin, TX (US)

(21) Appl. No.: 18/478,279

(22) Filed: Sep. 29, 2023

Related U.S. Application Data
(60) Provisional application No. 63/378,219, filed on Oct. 3, 2022.

(51) Int. Cl. G06F 16/2453; G06F 16/21

(52) U.S. Cl. CPC G06F 16/24542; G06F 16/212

(57) ABSTRACT

The present disclosure relates generally to computing and/or communications infrastructure and, more particularly, infrastructure for graph linking.

### BACKGROUND

### Field

The present disclosure relates generally to computing and/or communications infrastructure and, more particularly, infrastructure for graph linking.

### Information

The Internet is widespread. The World Wide Web or simply the Web, provided by the Internet, is growing rapidly, at least in part, from the large amount of content being added seemingly on a daily basis. A wide variety of content in the form of stored signals, such as, for example, text files, images, audio files, video files, web pages, measurements of physical phenomena, and/or the like may be continually acquired, identified, located, retrieved, collected, stored, communicated, etc. Increasingly, content is being acquired, collected, communicated, etc. by a number of electronic devices, such as, for example, embedded computing devices leveraging existing Internet and/or like infrastructure as part of a so-called “Internet of Things” (IoT), such as via a variety of protocols, domains, and/or applications. IoT may typically comprise a system of interconnected and/or internetworked physical computing devices capable of being identified, such as uniquely via an assigned Internet Protocol (IP) address, for example. Devices, such as IoT-type devices, for example, may include computing resources embedded into hardware so as to facilitate and/or support a device's ability to acquire, collect, process and/or transmit content over one or more communications networks. IoT-type devices, for example, may comprise a wide variety of embedded devices, such as, for example, automobile sensors, biochip transponders, heart monitoring implants, thermostats, kitchen appliances, locks or like fastening devices, solar panel arrays, home gateways, controllers, and/or the like.

In some instances, challenges may be faced in improving performance of communications between and/or among IoT-type devices and/or other electronic device types, for example. An aspect of communications related to IoT-type devices and/or other electronic device types, for example, may involve processing of one or more queries that may be generated at IoT-type devices and/or other electronic device types.

### BRIEF DESCRIPTION OF THE DRAWINGS

Claimed subject matter is particularly pointed out and distinctly claimed in the concluding portion of the specification. However, both as to organization and/or method of operation, together with objects, features, and/or advantages thereof, it may best be understood by reference to the following detailed description if read with the accompanying drawings in which:

FIG. 1 is a schematic block diagram depicting an embodiment of an example system including one or more server computing devices and/or one or more IoT-type devices, in accordance with an embodiment;

FIG. 2 is a schematic block diagram depicting an embodiment of an example Internet of Things (IoT) type device, in accordance with an embodiment;

FIG. 3 depicts an example graph implemented across multiple API services, in accordance with an embodiment;

FIG. 4 is an illustration depicting an example federated graph, in accordance with an embodiment;

FIG. 5 is a schematic block diagram depicting a further federated approach, in accordance with an embodiment;

FIG. 6 is an illustration depicting an example query in connection with a graph linking approach, in accordance with an embodiment;

FIG. 7 is a schematic block diagram depicting an example device, system and/or process for graph linking including a query linking multiple graph schemas, in accordance with an embodiment;

FIG. 8 is a schematic block diagram depicting an example device, system and/or process for graph linking wherein a graph schema links to multiple graphs, in accordance with an embodiment;

FIG. 9 is a flow diagram illustrating an example process for graph linking, in accordance with an embodiment; and

FIG. 10 depicts a schematic diagram illustrating an implementation of an example computing and/or communications environment, in accordance with an embodiment, in accordance with an embodiment.

Reference is made in the following detailed description to accompanying drawings, which form a part hereof, wherein like numerals may designate like parts throughout that are corresponding and/or analogous. It will be appreciated that the figures have not necessarily been drawn to scale, such as for simplicity and/or clarity of illustration. For example, dimensions of some aspects may be exaggerated relative to others. Further, it is to be understood that other embodiments may be utilized. Furthermore, structural and/or other changes may be made without departing from claimed subject matter. References throughout this specification to “claimed subject matter” refer to subject matter intended to be covered by one or more claims, or any portion thereof, and are not necessarily intended to refer to a complete claim set, to a particular combination of claim sets (e.g., method claims, apparatus claims, etc.), or to a particular claim. It should also be noted that directions and/or references, for example, such as up, down, top, bottom, and so on, may be used to facilitate discussion of drawings and are not intended to restrict application of claimed subject matter. Therefore, the following detailed description is not to be taken to limit claimed subject matter and/or equivalents.

### DETAILED DESCRIPTION

References throughout this specification to one implementation, an implementation, one embodiment, an embodiment, and/or the like means that a particular feature, structure, characteristic, and/or the like described in relation to a particular implementation and/or embodiment is included in at least one implementation and/or embodiment of claimed subject matter. Thus, appearances of such phrases, for example, in various places throughout this specification are not necessarily intended to refer to the same implementation and/or embodiment or to any one particular implementation and/or embodiment. Furthermore, it is to be understood that particular features, structures, characteristics, and/or the like described are capable of being combined in various ways in one or more implementations and/or embodiments and, therefore, are within intended claim scope. In general, of course, as has always been the case for the specification of a patent application, these and other issues have a potential to vary in a particular context of usage. In other words, throughout the patent application, particular context of description and/or usage provides helpful guidance regarding reasonable inferences to be drawn; however, likewise, “in this context” in general without further qualification refers to the context of the present patent application.

As mentioned above, the World Wide Web or simply the Web, provided by the Internet, is growing rapidly, at least in part, from the large amount of content being added seemingly on a daily basis. A wide variety of content in the form of stored signals, such as, for example, text files, images, audio files, video files, web pages, measurements of physical phenomena, and/or the like may be continually acquired, identified, located, retrieved, collected, stored, communicated, etc. Increasingly, content is being acquired, collected, communicated, etc. by a number of electronic devices, such as, for example, embedded computing devices leveraging existing Internet and/or like infrastructure as part of a so-called “Internet of Things” (IoT), such as via a variety of protocols, domains, and/or applications. IoT may typically comprise a system of interconnected and/or internetworked physical computing devices capable of being identified, such as uniquely via an assigned Internet Protocol (IP) address, for example. Devices, such as IoT-type devices, for example, may include computing resources embedded into hardware so as to facilitate and/or support a device's ability to acquire, collect, process and/or transmit content over one or more communications networks. In this context, “IoT-type devices” and/or the like refer to one or more electronic and/or computing devices capable of leveraging existing Internet and/or like infrastructure as part of the IoT, such as via a variety of applicable protocols, domains, applications, etc. In particular implementations, IoT-type devices, for example, may comprise a wide variety of embedded devices, such as, for example, automobile sensors, biochip transponders, heart monitoring implants, thermostats, kitchen appliances, locks or like fastening devices, solar panel arrays, home gateways, controllers, and/or the like. Although embodiments described herein may refer to IoT-type devices, claimed subject matter is not limited in scope in these respects. For example, although IoT-type devices may be described, claimed subject matter is intended to include use of any of a wide range of electronic device types, including a wide range of computing device types.

In some instances, challenges may be faced in improving performance of communications between and/or among IoT-type devices and/or other electronic device types, for example. An aspect of communications related to IoT-type devices and/or other electronic device types, for example, may involve processing of one or more queries that may be generated at IoT-type devices and/or other electronic device types.

“Electronic content,” “content” and/or the like as the terms are used herein should be interpreted broadly and refers to signals, such signal packets, for example, and/or states, such as physical states on a memory device, for example, but otherwise are employed in a manner irrespective of format, such as any expression, representation, realization, and/or communication, for example. Content may comprise, for example, any information, knowledge, and/or experience, such as, again, in the form of signals and/or states, physical or otherwise. In this context, “electronic” or “on-line” content refers to content in a form that although not necessarily capable of being perceived by a human, (e.g., via human senses, etc.) may nonetheless be transformed into a form capable of being so perceived, such as visually, haptically, and/or audibly, for example. Non-limiting examples may include text, audio, images, video, security parameters, combinations, or the like. Thus, content may be stored and/or transmitted electronically, such as before or after being perceived by human senses. In general, it may be understood that electronic content may be intended to be referenced in a particular discussion, although in the particular context, the term “content” may be employed for ease of discussion. Specific examples of content may include, for example, computer code, data, metadata, message, text, audio file, video file, data file, web page, or the like. Claimed subject matter is not intended to be limited to these particular examples, of course.

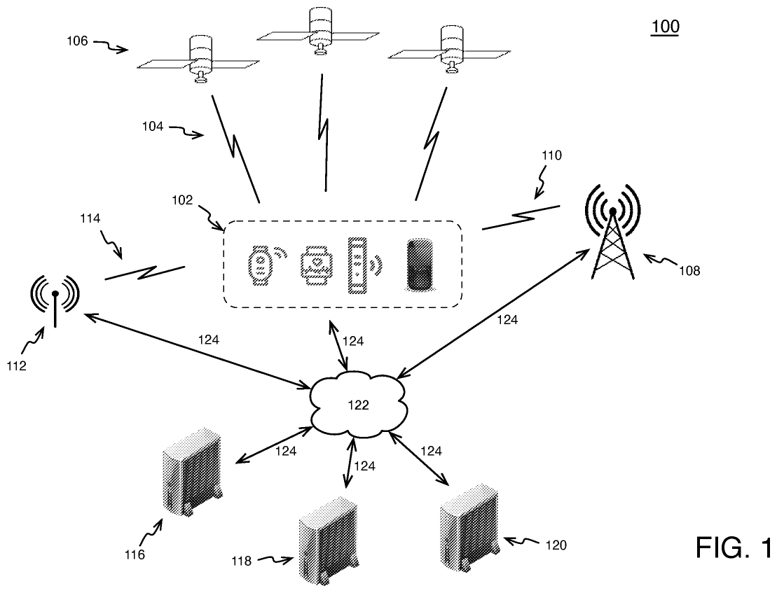

FIG. 1 is a schematic diagram illustrating features associated with an implementation of an example operating environment 100 capable of facilitating and/or supporting one or more operations and/or techniques for infrastructure for updating and/or managing IoT-type devices, illustrated generally herein at 102. As was indicated, the IoT is typically a system of interconnected and/or internetworked physical devices in which computing may be embedded into hardware so as to facilitate and/or support devices' abilities to acquire, collect and/or communicate content over one or more communications networks, for example, at times, without human participation and/or interaction. As mentioned, IoT-type devices may include a wide variety of stationary and/or mobile devices, such as, for example, automobile sensors, biochip transponders, heart monitoring implants, kitchen appliances, locks or like fastening devices, solar panel arrays, home gateways, smart gauges, smart telephones, cellular telephones, security cameras, wearable devices, thermostats, Global Positioning System (GPS) transceivers, personal digital assistants (PDAs), virtual assistants, laptop computers, personal entertainment systems, tablet personal computers (PCs), PCs, personal audio and/or video devices, personal navigation devices, and/or the like.

It should be appreciated that operating environment 100 is described herein as a non-limiting example that may be implemented, in whole or in part, in a context of various wired and/or wireless communications networks and/or any suitable portion and/or combination of such networks. For example, these or like networks may include one or more public networks (e.g., the Internet, the World Wide Web), private networks (e.g., intranets), wireless wide area networks (WWAN), wireless local area networks (WLAN, etc.), wireless personal area networks (WPAN), telephone networks, cable television networks, Internet access networks, fiber-optic communication networks, waveguide communication networks and/or the like. It should also be noted that claimed subject matter is not limited to a particular network and/or operating environment. Thus, for a particular implementation, one or more operations and/or techniques for updating and/or managing IoT-type devices may be performed, at least in part, in an indoor environment and/or an outdoor environment, or any combination thereof.

Thus, as illustrated, in a particular implementation, one or more IoT-type devices 102 may, for example, receive and/or acquire satellite positioning system (SPS) signals 104 from SPS satellites 106. In some instances, SPS satellites 106 may be from a single global navigation satellite system (GNSS), such as the GPS or Galileo satellite systems, for example. In other instances, SPS satellites 106 may be from multiple GNSS such as, but not limited to, GPS, Galileo, Glonass, or Beidou (Compass) satellite systems, for example. In certain implementations, SPS satellites 1006 may be from any one several regional navigation satellite systems (RNSS) such as, for example, WAAS, EGNOS, QZSS, just to name a few examples.

At times, one or more IoT-type devices 102 may, for example, transmit wireless signals to and/or receive wireless signals from a suitable wireless communication network. In one example, one or more IoT-type devices 102 may communicate with a cellular communication network, such as by transmitting wireless signals to and/or receiving wireless signals from one or more wireless transmitters capable of transmitting and/or receiving wireless signals, such as a base station transceiver 108 over a wireless communication link 110, for example. Similarly, one or more IoT-type devices 102 may transmit wireless signals to and/or receive wireless signals from a local transceiver 112 over a wireless communication link 114, for example. Base station transceiver 108, local transceiver 112, etc. may be of the same or similar type, for example, and/or may represent different types of devices, such as access points, radio beacons, cellular base stations, femtocells, an access transceiver device, or the like, depending on an implementation. Similarly, local transceiver 112 may comprise, for example, a wireless transmitter and/or receiver capable of transmitting and/or receiving wireless signals. For example, at times, wireless transceiver 112 may be capable of transmitting and/or receiving wireless signals from one or more other terrestrial transmitters and/or receivers.

In a particular implementation, local transceiver 112 may, for example, be capable of communicating with one or more IoT-type devices 102 at a shorter range over wireless communication link 114 than at a range established via base station transceiver 108 over wireless communication link 110. For example, local transceiver 112 may be positioned in an indoor or like environment and/or may provide access to a wireless local area network (WLAN, e.g., IEEE Std. 802.11 network, etc.) and/or wireless personal area network (WPAN, e.g., Bluetooth® network, etc.). In another example implementation, local transceiver 112 may comprise a femtocell and/or picocell capable of facilitating communication via link 114 according to an applicable cellular or like wireless communication protocol. Again, it should be understood that these are merely examples of networks that may communicate with one or more IoT-type devices 102 over a wireless link, and claimed subject matter is not limited in this respect. For example, in some instances, operating environment 100 may include a larger number of base station transceivers 108, local transceivers 112, networks, terrestrial transmitters and/or receivers, etc.

In an implementation, one or more IoT-type devices 102, base station transceiver 108, local transceiver 112, etc. may, for example, communicate with one or more servers, referenced herein at 116, 118, and 120, over a network 122, such as via one or more communication links 124. Network 122 may comprise, for example, any combination of wired and/or wireless communication links. In a particular implementation, network 122 may comprise, for example, Internet Protocol (IP)-type infrastructure capable of facilitating or supporting communication between one or more IoT-type devices 102 and one or more servers 116, 118, 120, etc. via local transceiver 112, base station transceiver 108, directly, etc. In another implementation, network 122 may comprise, for example cellular communication network infrastructure, such as a base station controller and/or master switching center to facilitate and/or support mobile cellular communication with one or more IoT-type devices 102. Servers 116, 118 and/or 120 may comprise any suitable servers or combination thereof capable of facilitating or supporting one or more operations and/or techniques discussed herein. For example, servers 116, 118 and/or 120 may comprise one or more update servers, back-end servers, management servers, archive servers, location servers, positioning assistance servers, navigation servers, map servers, crowdsourcing servers, network-related servers, or the like.

Even though a certain number of computing platforms and/or devices are illustrated herein, any number of suitable computing platforms and/or devices may be implemented to facilitate and/or support one or more techniques and/or processes associated with operating environment 100. For example, at times, network 122 may be coupled to one or more wired and/or wireless communication networks (e.g., WLAN, etc.) so as to enhance a coverage area for communications with one or more IoT-type devices 102, one or more base station transceivers 108, local transceiver 112, servers 116, 118, 120, or the like. In some instances, network 122 may facilitate and/or support femtocell-based operative regions of coverage, for example. Again, these are merely example implementations, and claimed subject matter is not limited in this regard.

In this context, “IoT-type devices” refer to one or more electronic and/or computing devices capable of leveraging existing Internet or like infrastructure as part of the so-called “Internet of Things” or IoT, such as via a variety of applicable protocols, domains, applications, etc. As was indicated, the IoT is typically a system of interconnected and/or internetworked physical devices in which computing may be embedded into hardware so as to facilitate and/or support devices' ability to acquire, collect, and/or communicate content over one or more communications networks, for example, at times, without human participation and/or interaction. IoT-type devices 102, for example, may include a wide variety of stationary and/or mobile devices, such as, for example, automobile sensors, biochip transponders, heart monitoring implants, kitchen appliances, locks or like fastening devices, solar panel arrays, home gateways, smart gauges, smart telephones, cellular telephones, security cameras, wearable devices, thermostats, Global Positioning System (GPS) transceivers, personal digital assistants (PDAs), virtual assistants, laptop computers, personal entertainment systems, tablet personal computers (PCs), PCs, personal audio or video devices, personal navigation devices, and/or the like, to name a few non-limiting examples. Typically, in this context, a “mobile device” refers to an electronic and/or computing device that may from time to time have a position or location that changes, and/or a stationary device refers to a device that may have a position or location that generally does not change. In some instances, IoT-type devices, such as IoT-type devices 102, may be capable of being identified, such as uniquely, via an assigned Internet Protocol (IP) address, as one particular example, and/or having an ability to communicate, such as receive and/or transmit electronic content, for example, over one or more wired and/or wireless communications networks.

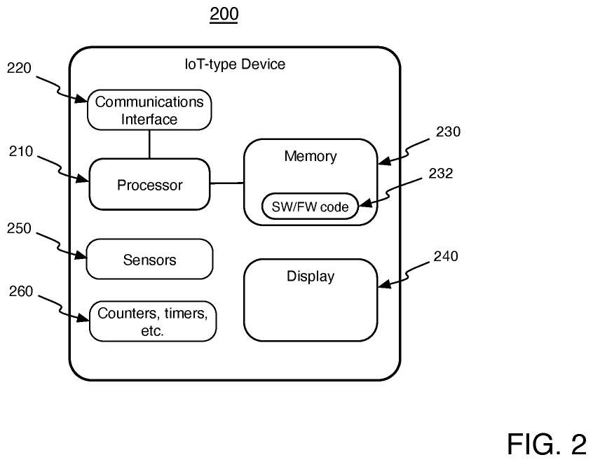

FIG. 2 is an illustration of an embodiment 200 of an example particular IoT device. Of course, claimed subject matter is not limited in scope to the particular configurations and/or arrangements of components depicted and/or described for example devices mentioned herein. In an embodiment, an IoT-type device, such as 200, may comprise one or more processors, such as processor 210, and/or may comprise one or more communications interfaces, such as communications interface 220. In an embodiment, one or more communications interfaces, such as communications interface 220, may enable wireless communications between an electronic device, such as an IoT-type device 200, and one or more other computing devices. In an embodiment, wireless communications may occur substantially in accordance any of a wide range of communication protocols, such as those mentioned herein, for example.

In a particular implementation, an IoT-type device, such as IoT-type device 200, may include a memory, such as memory 230. In a particular implementation, memory 230 may comprise a non-volatile memory, for example. Further, in a particular implementation, a memory, such as memory 230, may have stored therein executable instructions, such as for one or more operating systems, communications protocols, and/or applications, for example. A memory, such as 230, may further store particular instructions, such as software and/or firmware code 232, that may be updated via one or more example implementations and/or embodiments described herein. Further, in a particular implementation, an IoT-type device, such as IoT-type device 200, may comprise a display, such as display 240, and/or one or more sensors, such as one or more sensors 250. As utilized herein, “sensors” and/or the like refer to a device and/or component that may respond to physical stimulus, such as, for example, heat, light, sound pressure, magnetism, particular motions, etc., and/or that may generate one or more signals and/or states in response to physical stimulus. Example sensors may include, but are not limited to, one or more accelerometers, gyroscopes, thermometers, magnetometers, barometers, light sensors, proximity sensors, hear-rate monitors, perspiration sensors, hydration sensors, breath sensors, cameras, microphones, etc., and/or any combination thereof.

In particular implementations, IoT-type device 200 may include one or more timers and/or counters and/or like circuits, such as circuitry 260, for example. In an embodiment, one or more timers and/or counters and/or the like may track one or more aspects of device performance and/or operation. For example, timers, counters, and/or other like circuits may be utilized, at least in part, by IoT-type device 200 to determine measures of fitness, for example, and/or to otherwise generate feedback content related to testing results, in particular implementations.

Although FIG. 2 depicts a particular example implementation of an IoT-type device, such as IoT-type device 200, other embodiments may include other types of electronic and/or computing devices. Example types of electronic and/or computing devices may include, for example, any of a wide range of digital electronic devices, including, but not limited to, desktop and/or notebook computers, high-definition televisions, digital video players and/or recorders, game consoles, satellite television receivers, cellular telephones, tablet devices, wearable devices, personal digital assistants, mobile audio and/or video playback and/or recording devices, or any combination of the foregoing.

In an embodiment, a client computing device (e.g., via execution of an application), such as IoT-type device 200, may generate one or more queries, such as a query that may include a content request. A variety of query languages may exist to formulate queries for specific content being sought. Examples of query languages may include Structured Query Language (SQL), XML Path Language (XPATH), and/or GraphQL, but these are just illustrative examples. The term Structured Query Language, SQL, and/or similar terms are intended to refer to any version, now known and/or to be later developed of the Structured Query Language. Similarly, the term XML Path Language, XPATH, and/or similar terms are intended to refer to any version, now known and/or to be later developed, of the XML Path Language. Likewise, the term GraphQL, and/or similar terms are intended to refer to any version, now known and/or to be later developed, of the GraphQL query language. Furthermore, as used herein, the terms query, query request, queries and/or the like are intended to refer to one or more queries formulated in a particular query language, such as one of the foregoing languages, for example. Also, although embodiments and/or implementations described herein may refer to queries, other embodiments and/or implementations may include other types of operations such as mutations, for example.

In embodiments, GraphQL may comprise a query language for an application programming interface (API) and/or a server-side runtime service for executing queries using a type system and/or the like that may be defined for content to be sought. In particular implementations, GraphQL may not be tied to any specific database and/or storage engine and/or may instead be backed by existing code and/or content.

A GraphQL schema, for example, may comprise a specification of a set of content types and/or structures, levels of nesting, and/or fields, etc., for example, which may indicate content available, such as to be queried. Similarly, a GraphQL query path may specify that for certain content fields a path may be followed and/or traversed to locate such content, such as in a repository. A GraphQL query shape likewise may specify relationships within a GraphQL schema, such as for content types, etc., including interrelationships, nesting and/or other forms of association, for example.

As utilized herein, “graph” and/or the like represents a structure that may include points connected by edges, for example. Additionally, “data graph” and/or the like represents a model of content (e.g., data) available from a service structured as a graph. In an implementation, a graph may have a number of properties. For example, in an implementation, a graph may comprise “points” and/or the like that may represent objects and/or properties. Points may optionally contain binary or textual data, for example. Graphs may also include “edges” and/or the like that may represent relationships, for example. Also, in implementations, graphs may include queries that may terminate at certain points and/or that may change a graph in accordance with the following: a) queries may add or remove points; b) queries may add or remove edges connecting points; and/or c) queries may add, remove, or modify the data attached to points, for example. In implementations, one or more points may be tagged as roots for different categories of queries. For example, a query root may be provided such that queries that begin at a query root provide, but do not modify, graph content. In an implementation, a separate mutation root may be identified such that queries that begin at the mutation root may both modify and read graph data, for example.

As utilized herein, a “graph schema” and/or the like represents a description of an expected structure of a data graph. In an implementation, rather than enumerate points and edges (e.g., a representation that may be as large or even frequently much larger than content to be sought itself), a graph schema may provide a type system for the data graph with various example properties. For example, a graph schema may assign a “type” to points (e.g., every point in particular implementations) within a data graph. In implementations, a schema may specify constraints some point p may satisfy to be included within a type, including but not limited to: a) presence of one or more edges fulfilling arbitrary criteria beginning at p; and b) presence and/or shape of content contained by a point, for example. Further, for example, a graph schema may assign a “field” to edges (e.g., every edge in particular implementations) within a data graph. For example, fields may comprise a generalization over edges. In implementations, whereas an edge may describe a connection between specific objects in a data graph, fields may describe a connection between types. That is, fields may represent a class of relationship that may be represented between objects, for example. Also, in implementations, fields may be parameterized to represent a wider range of relationships. For example, a schema may define a User.friends(first: Int)->[User] field, which may connect a user to a list of their friends, limited in size to the specified number of friends. This example field may represent an unbounded number of edges, including “user A's first friend on the service”, “user A's first two friends”, “user A's first three friends”, etc.

In implementations, a graph schema may define a “type graph” that may represent relationships between types. For example, within a type graph, points may comprise types and/or edges that may comprise “casts” representing relationships that types may have with each other. In a particular implementation, given two types A and B, the following relationships are possible: a) A may comprise a proper superset of B if all points within B also fall within A. In this case, B may have an unconditional edge to A and A may have a conditional edge to B; b) A may overlap with B if some but not all points within B are in A and some but not all points within A are in B. In this case, A and B may have conditional edges to each other; and/or c) A and B may be non-overlapping if there exist no points which are shared between them. In this case, no edges will exist between A and B. In implementations, there may exist a number of possible textual representations (e.g., encodings) of a graph schema, for example.

In implementations, a GraphQL service may be generated at least in part by defining types and/or fields on those types. For example, a GraphQL service that may indicate an identity of a logged-in user is (e.g., “me”) as well as that logged-in user's name might look like the following:

```
type Query {
  me: User
}
type User {
  id: ID
  name: String
}
```

In implementations, once running (e.g., at a URL on a web service) a GraphQL service (e.g., endpoint) may receive GraphQL queries to validate and/or execute. A GraphQL service may first check a query to ensure it refers to the types and/or fields defined and then may run specified functions to produce a result. For example, a query:

```
{
  me {
    name
  }
}
```

may generate the following JSON result, for example:

```
{
  “me”: {
    “name”: “Luke Skywalker”
  }
}
```

In implementations, an example GraphQL query language may relate at least in part to selecting fields on objects.

```
{
  hero {
    name
    appearsIn
  }
}
{
  “data”: {
    “hero”: {
      “name”: “R2-D2”,
      “appearsIn”: [
        “NEWHOPE”,
        “EMPIRE”,
        “JEDI”
      ]
    }
  }
}
```

For the example query shown above, processing may begin with a special “root” object. Subsequently, the “hero” field may be selected, for example. For the object returned by “hero,” the “name” and “appearsIn” fields may be selected, for example.

In at least some circumstances, it may be advantageous and/or beneficial to have a more exact description of the content (e.g., data) one may ask for—what fields can one select? What kinds of objects might the fields return? What fields are available on those sub-objects? In implementations, a schema, such as a GraphQL schema, may help provide the aforementioned advantages and/or benefits, as explained more fully below.

In implementations, a schema, such as a GraphQL schema, may define a set of types which may describe (e.g., may completely describe in particular implementations) a set of possible content one may access on a particular service. In an implementation, responsive at least in part to receiving one or more queries, the one or more queries may be validated and/or executed against the particular schema, for example.

In implementations, GraphQL services may be written in any language. Because one may not rely on a specific programming language syntax, like JavaScript, to discuss GraphQL schemas, an example GraphQL schema language, similar in at least some respects to a GraphQL query language, may be utilized herein for various examples to allow language-agnostic discussion of schemas, such as GraphQL schemas. Although example embodiments and/or implementations may be described herein, at least in part, in connection with GraphQL, subject matter is not limited in scope in this respect. That is, GraphQL is utilized herein as a non-limiting example.

In implementations, basic components of a GraphQL schema may comprise object types, which may represent a kind of object that may be fetched from a service, and what fields the object types may have. In an example GraphQL schema language, an example object type may be represented as follows:

```
type Character {
  name: String!
  appearsIn: [Episode!]!
}
```

For the example above, “Character” may comprise a GraphQL Object Type, meaning it's a type with some fields. Many, or most, of the types in a schema may comprise object types, for example. Also, for example, “name” and “appearsIn” may comprise fields on the Character type. For example, name and appearsIn may comprise fields that may appear in a part of a GraphQL query that operates on the Character type. “String,” for example, may comprise one of the built-in scalar types. Scalar types may resolve to a single scalar object and may not have sub-selections in a query, for example. Further, “String!” may specify that a field is non-nullable, meaning that the GraphQL service may always provide a value when this field is queried. In the example type language, non-nullable fields may be represented as those with an exclamation mark. Additionally, [Episode!]! may represents an array of Episode objects. Because it may also be non-nullable, one may expect an array (e.g., with zero or more items) in response to the appearsIn field being queried. Also, because Episode! may also be non-nullable, one may expect individual items of the array to be Episode objects, for example.

The above discussion may provide some understanding of what an example GraphQL object type may look like and/or may also provide some understanding of how to read some basics of an example GraphQL-type language. In implementations, an organization may advantageously expose a single graph that may provide a unified interface for querying various combinations of content sources. However, it may be challenging to represent an enterprise-scale graph with a single, monolithic GraphQL service, for example.

To address this challenge, at least in part, a federated approach may be utilized to divide a graph implementation into multiple services that may be maintained more easily by different teams. An example architecture utilizing a federated approach may include, for example, a collection of subgraphs (e.g., usually represented as different API services) that may individually define a particular GraphQL schema. For example, multiple GraphQL subgraphs may be declaratively composed to create a unified set of types in a unified supergraph schema. Further, for example, a graph router may utilize the declaratively composed unified supergraph schema (e.g., composed from multiple GraphQL subgraph schemas) to execute operations, such as queries, for example, across the multiple GraphQL subgraphs to provide clients access to all of the types and fields in the composed supergraph.

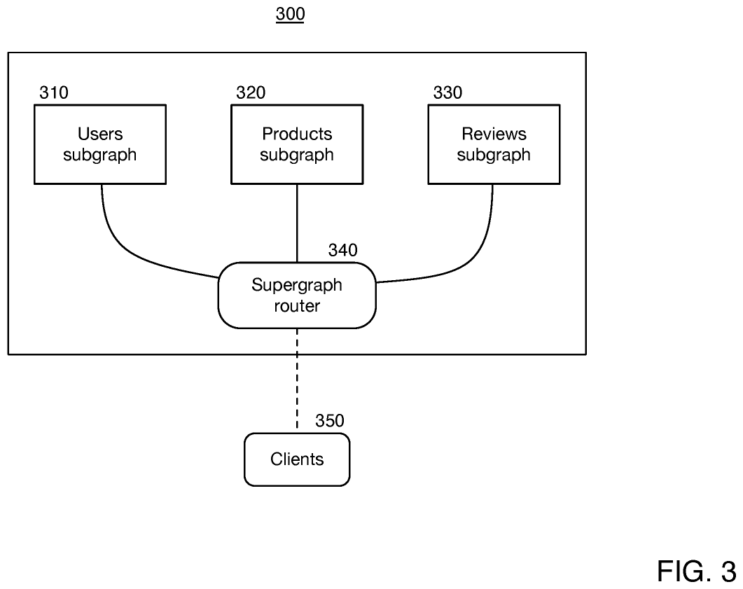

For example, as depicted in FIG. 3, a graph (e.g., supergraph), such as supergraph 300, may have its implementations spread across multiple API services including, for example, a first subgraph, such as “Users” subgraph 310, a second subgraph, such as “Products” subgraph 320, and/or a third subgraph, such as “Reviews” subgraph 330. Subgraphs 310, 320 and/or 330, for example, may be composed into supergraph 300. By querying supergraph 300, one or more client computing devices or clients 350 may query any or all of subgraphs 310, 320 and/or 330 at the same time, for example. In an implementation, a graph router, such as graph router 340, may serve as an access point for a supergraph, such as supergraph 300. In an implementation, a graph router, such as graph router 340, may receive incoming GraphQL operations (e.g., queries) and/or may intelligently distribute the incoming GraphQL operations across subgraphs, such as subgraphs 310, 320 and/or 330. From the perspective of clients 350, querying subgraphs via graph router 340 may look the same as querying any other GraphQL server (e.g., no special configuration may be needed), for example.

Unlike other distributed GraphQL architectures such as, for example, schema stitching, a federated approach may utilize a declarative composition model that may enable individual subgraphs to implement a specified part of a composed supergraph for which the individual subgraphs may be responsible. Unlike schema stitching, which may require manually authored imperative code in Javascript (a specific programming language) to stitch schemas together at runtime, for example, a federated approach may declaratively compose subgraph schemas into a single unified supergraph schema, validate a single supergraph schema at build-time for correctness, for example, and/or may load the supergraph schema into a federated GraphQL runtime like a graph router to serve client queries and perform other GraphQL operations at runtime. Unlike schema stitching, a federated approach may use GraphQL schema to describe the modular subgraph schemas that will be composed, which is independent of the programming language used to build a subgraph server. As such, a declarative, federated approach to composing subgraph schemas into a unified supergraph schema may be agnostic to the programming language used to author the GraphQL server, unlike schema stitching which may be tied to Javascript, a specific programming language. A federated approach may also enable one to add, remove, and/or refactor subgraphs without incurring downtime for production graphs, for example.

Unlike other data access approaches, for example databases which also use schemas and/or may have a query planner to execute queries, a federated GraphQL architecture may use GraphQL instead of SQL to define data structures and queries and/or may access GraphQL subgraphs on a network instead of database tables on disk. Also, a federated GraphQL approach may not in at least some circumstances offer a durable and/or persistent store of data itself, but rather may be layered on top of underlying network services (e.g., GraphQL APIs, REST APIs, and/or microservices) that may in turn use a database or other data store. Relational databases may be built with multiple tables that may refer to each other. For example, rows from one table may refer to specific rows in another table which may be connected by some ID column(s). One may SELECT fields FROM multiple database tables and join them together using keys or IDs that match a WHERE clause. In this way, one may spread the data for an entity across multiple database tables and/or may join them together using a SQL query that may then be processed by a database query planning engine to create a query plan, execute it by fetching data from the underlying database tables on disk and/or collate and return the results to the client. In a similar way, a federated approach may allow one to spread the implementation of entity types in a graph across multiple subgraphs where a graph router can process a query and/or join entity fields together by dynamically creating a query plan at runtime to advantageously (e.g., optimally) fetch the entity fields from the respective subgraph API servers using entity keys. A federated GraphQL approach may be agnostic to the underlying database or microservice technologies used and may be used to create a unified graph layer on top of multiple underlying microservices (e.g., REST APIs, gRPC, etc.) that may in turn each use different database technologies. A federated approach may provide a single GraphQL schema that application developers may use to access data and services in an organization or across organizations on the public Internet, for example.

As utilized herein, “entity” refers to an object type that can resolve its fields across multiple subgraphs. Individual subgraphs may contribute different fields to the entity and may be responsible for resolving only the fields that it contributes. In implementations, an entity may be defined within a particular subgraph by assigning the particular entity's @key GraphQL schema directive and/or by defining the particular entity's reference resolver. Entity references are discussed below.

In federated GraphQL implementations, libraries may be provided to allow a server to act as a GraphQL subgraph and/or as a graph router, for example. Such components may be implemented in any language and/or framework.

In an implementation, a federated approach may be adopted incrementally. For example, for implementations using a monolithic GraphQL server, functionality may be converted to a federated approach one service at a time. Further, for example, for implementations using other architectures (e.g., schema stitching), support for a federated approach may be added to existing services one at a time. In such cases, clients may continue to work and/or may have no way to distinguish between different graph implementations. Thus, a federated approach may be adopted and/or implemented without adverse implications to clients, for example.

In implementations, a federated approach may encourage a design principle that may be referred to as “separation of concerns.” Such a principle may enable different teams within an enterprise to work on different products and/or features within a single graph without interfering with each other.

When considering how to split a single GraphQL schema across multiple subgraphs, it may seem straightforward to divide schemas up by type. For example, a “users” subgraph may define a User type, a “products” subgraph may define a Product type, and so on:

```
Users subgraph:
type User {
  id: ID!
  name: String
  reviews: [Review]
  purchases: [Product]
}
Products subgraph:
type Product {
  id: ID!
  name : String
  price: String
  reviews: [Review]
}
Reviews subgraph:
type Review {
  id: ID!
  body: String
  author: User
  product: Product
}
```

Although this separation may appear relatively straightforward, it may pose issues. For example, a particular feature and/or concern may sometimes span multiple types. Consider, for example, the User.purchases field of the User type in the above schema. Even though this field is a member of the User type, a list of Products should probably be populated by the Products subgraph rather than the Users subgraph. In implementations, by defining the User.purchases field in the Products subgraph instead, the subgraph that defines the field may also be the subgraph that specifies how to populate the field. In some circumstances, the Users subgraph might not even have access to the content store that contains product content, for example. Also, by defining the User.purchases field in the Products subgraph, for example, the team that manages product content may contain product-related logic in a single subgraph for which they may be responsible.

The following example schema uses a federated approach to divide the same set of types and fields across the same three subgraphs (note: some federation-specific syntax is omitted here for clarity and/or ease of explanation):

```
Users subgraph
type User {
  id: ID!
  name: String
}
Products subgraph
type Product {
  id: ID!
  name : String
  price: String
}
type User {
  id: ID!
  purchases: [Product]
}
Reviews subgraph
type Review {
  id: ID!
  body: String
  author: User
  product: Product
}
type User {
  id: ID!
  reviews: [Review]
}
type Product {
  id: ID!
  reviews: [Review]
}
```

The difference is that now, individual subgraphs may define (e.g., may at least mostly define) types and/or fields that they are capable of, and/or may be responsible for, populating from their respective content stores, for example. The result may be the best of both worlds: an implementation that keeps code for a given feature in a single subgraph and separated from unrelated concerns and a product-centric schema with rich types that may reflect the way an application developer may want to consume the graph, for example.

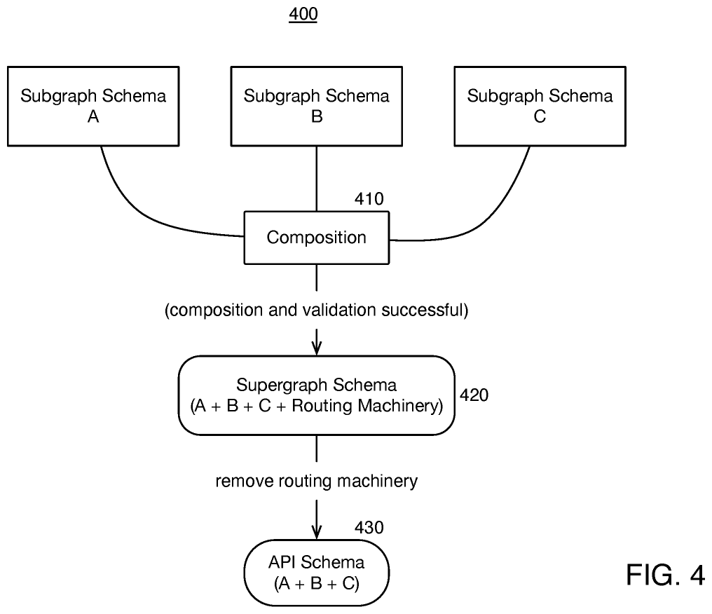

FIG. 4 is an illustration depicting an example federated graph 400. In implementations, a federated graph, such as graph 400, may utilize multiple types of GraphQL schemas. For example, subgraphs schemas, such as subgraph schemas A, B, and/or C, may individually comprise distinct schemas that may indicate which types and/or fields that a composed supergraph schema, such as supergraph schema 420, may be responsible for resolving. A supergraph schema, such as supergraph schema 420, may comprise the result of performing composition, such as composition operation 410, on a collection of subgraph schemas, such as subgraph schemas A, B, and/or C. A supergraph schema may combine all of the types and/or fields from subgraph schemas plus some federation-specific directives that may instruct a graph router as to which subgraphs may be responsible for resolving particular fields, in implementations.

Additionally, an API schema, such as API schema 430, may resemble a supergraph schema, such as supergraph schema 420, in some respects, but it may omit types, fields, and/or directives that may be considered “machinery” and may not be part of a public API that GraphQL clients use directly. This may include federation-specific and/or user-defined directives, for example. An API schema, such as API schema 430, may be exposed in a graph router to a GraphQL API's consumers who may not need to know any internal implementation details about a particular graph, for example.

Consider an example. Below, schemas may be defined for three subgraphs in a basic example e-commerce application. Individual subgraphs may be implemented as a separate GraphQL API, for example:

```
Users subgraph
type Query {
    me: User
}
type User @key(fields: “id”) {
    id: ID!
    username: String! @shareable
}
# (Subgraph schemas include
# this to opt in to
# Federation 2 features.)
extend schema
    @link(url: “https://specs.apollo.dev/federation/v2.0”,
    import: [“@key”, “@shareable”])
Products Subgraph
type Query {
    topProducts(first: Int = 5): [Product]
}
type Product @key(fields: “upc”) {
  upc: String!
  name: String!
  price: Int
}
extend schema
@link(url: “https://specs.apollo.dev/federation/v2.0”,
import: [“@key”, “@shareable”])
Reviews subgraph
type Review {
body: String
author: User @provides(fields: “username”)
product: Product
}
type User @key(fields: “id”) {
id: ID!
username: String! @external
reviews: [Review]
}
type Product @key(fields: “upc”) {
upc: String!
reviews: [Review]
}
# (This subgraph uses additional
# federated directives)
extend schema
@link(url: “https://specs.apollo.dev/federation/v2.0”,
import: [“@key”, “@shareable”, “@provides”, “@external”])
```

As the above example schemas show, multiple subgraphs may contribute unique fields to a single type. For example, the Products subgraph and the Reviews subgraph both contribute fields to the Product type.

In implementations, a supergraph schema, such as supergraph schema 800, may comprise the output of schema composition, such as schema composition operation 410 depicted in FIG. 4. In implementations, a supergraph schema may provide a graph router, such as graph router 340, with the name and endpoint URL for the individual subgraphs. A supergraph schema, such as supergraph schema 420, for example, may include types, fields and/or directives (e.g., all, most, etc. of the types, fields and/or directives) defined by the subgraph schemas, for example. Also, in an implementation, a supergraph schema may tell the graph router which of the subgraph schemas can resolve which GraphQL fields, for example. A supergraph schema example provided below represents an example result of a composition operation performed utilizing the example subgraph schemas provided above.

```
Supergraph Schema
@link(url: “https://specs.apollo.dev/link/v1.0”)
@link(url: “https://specs.apollo.dev/join/v0.2”, for: EXECUTION)
{
query: Query
}
directive @join_field(graph: join_Graph!, requires: join_FieldSet,
provides: join_FieldSet, type:
String, external: Boolean, override: String, usedOverridden: Boolean)
repeatable on
  FIELD_DEFINITION | INPUT_FIELD_DEFINITION
directive @join_graph(name: String!, url: String!) on ENUM_VALUE
directive @join_implements(graph: join_Graph!, interface: String!)
repeatable on OBJECT |
INTERFACE
directive @join_type(graph: join_Graph!, key: join_FieldSet, extension:
Boolean! = false,
resolvable: Boolean! = true) repeatable on OBJECT | INTERFACE |
UNION | ENUM |
INPUT_OBJECT | SCALAR
directive @link(url: String, as: String, for: link_Purpose, import:
[link_Import]) repeatable on
SCHEMA
scalar join_FieldSet
enum join_Graph {
PRODUCTS @join_graph(name: “products”, url:
“http://localhost:4003/graphql”)
REVIEWS @join_graph(name: “reviews”, url:
“http://localhost:4002/graphql”)
USERS @join_graph(name: “users”, url: “http://localhost:4001/graphql”)
}
scalar link_Import
enum link_Purpose {
  “““
  ‘SECURITY’ features provide metadata necessary to securely resolve
fields.
  ”””
  SECURITY
  “““
  ‘EXECUTION’ features provide metadata necessary for operation
execution.
  ”””
  EXECUTION
}
type Product
@join_type(graph: PRODUCTS, key: “upc”)
@join
type(graph: REVIEWS, key: “upc”)
{
upc: String!
name: String! @join_field(graph: PRODUCTS)
price: Int @join_field(graph: PRODUCTS)
reviews: [Review] @join_field(graph: REVIEWS)
}
type Query
@join_type(graph: PRODUCTS)
@join_type(graph: REVIEWS)
@join_type(graph: USERS)
{
topProducts(first: Int = 5): [Product] @join_field(graph: PRODUCTS)
me: User @join_field(graph: USERS)
}
type Review
@join_type(graph: REVIEWS)
{
body: String
author: User @join_field(graph: REVIEWS, provides: “username”)
product: Product
}
type User
@join_type(graph: REVIEWS, key: “id”)
@join_type(graph: USERS, key: “id”)
{
id: ID!
username: String! @join_field(graph: REVIEWS, external: true)
@join_field(graph: USERS)
reviews: [Review] @join_field(graph: REVIEWS)
}
```

In implementations, a graph router, such as graph router 340, may utilize a supergraph schema, such as supergraph schema 420, to generate a GraphQL API schema, such as API schema 430, that clients of the graph router may use to introspect the API schema (e.g., to browse the available types and/or root query fields), to issue GraphQL queries and/or to perform other GraphQL operations on the graph router. An API schema, such as the example API schema provided below, may represent the combination of the various subgraph schemas:

type Product {
name: String!
price: Int
reviews: [Review]
upc: String!
}
type Query {
me: User
topProducts(first: Int = 5): [Product]
}
type Review {
author: User
body: String
product: Product
}
type User {
id: ID!
reviews: [Review]
username: String!
}

As explained, an enterprise may have one unified graph (e.g., supergraph) as opposed to multiple graphs created by different teams, for example (of course, enterprises may utilize multiple unified supergraphs if they prefer and/or if advantageous). By having a unified graph, the value of GraphQL may be enhanced. More content and/or services may be accessed from a single query. For example, API-side joins may combine all of the fields for a particular entity, even if spread across multiple subgraphs, so that a single integrated result may be returned to the client. In this manner, the client need not stitch together the results, unlike other approaches that may batch individual requests to different subgraphs in a single query and then the client has to manually stitch these results together. API-side joins may be similar in at least some respects to database joins across tables, although with a GraphQL federated approach joins may be performed across multiple subgraphs instead of tables, for example. Having an ability to perform API-side joins rather than client-side joins may provide advantages in terms of runtime performance and/or in terms of simplifying and/or reducing work for application developers, for example. With a GraphQL federated approach, a unified graph may provide for a single source of truth for a number (e.g., all, most, etc.) of services and/or may provide faster apps, quicker software delivery, reduced maintenance overhead, etc. Also, for example, code, queries, skills and/or experience may be more portable across teams. A unified graph may also yield a central catalog of available content (e.g., schema registry) to which graph users may look, for example. Further, implementation costs may be reduced due at least in part to at least a good deal of graph implementation work not being duplicated across teams. Additionally, for example, central management of a graph may be unified across control policies. “Unified graph” and/or the like in this context refers to a graph composed from one or more graphs, such as subgraphs. “Supergraph” and/or the like refers to an example unified graph composed from one or more subgraphs. “Unified graph” and/or the like and “supergraph” and/or the like may be utilized herein interchangeably.

In implementations, although there may only be a single graph, implementation of that graph may be federated across multiple teams within an enterprise. For example, monolithic architectures may be difficult to scale without specialized infrastructure and/or without significant negative impact to productivity (e.g., due to various teams having to coordinate with each other), and graphs may be no exception. Instead of implementing an organization's entire graph layer in a single codebase, for example, responsibility for defining and/or implementing a graph may be divided across multiple teams. In implementations, individual teams may be responsible for maintaining the portion of a schema that exposes their content and/or services while having the flexibility to develop independently and/or operate on their own release cycle. This may maintain advantages of a single, unified graph while decoupling development efforts across an entity, for example. These example characteristics of a GraphQL federated approach may be key to efficiently scaling a graph across multiple teams so that each team can work on their particular module or slice of the graph in an autonomous fashion with independent delivery of their slice, thereby reducing the exponential comms overhead that may be experienced with other (e.g., monolithic) approaches.

In implementations, a fundamental property of federation (FPF) specifies that theoretically possible queries of interest (e.g., one or more queries of interest, all queries of interest, etc.) for a particular supergraph API schema can be served through a number of sub-queries on the subgraphs. For a particular federated approach, such as the approach discussed previously, the FPF may be enforced at least in part by specifying particular rules. For example, for a particular federated approach, three object types may be specified, with individual object types being allowed a single type of subgraph layout. For example, for a particular federated approach, if an entity type has an @key, that key may be used to join fields for an entity across subgraphs (and API-side join), using the @key to index and/or select the required fields from each subgraph. The @key may be used to spread the implementation of an entity type across multiple subgraphs (excluding @provides, in an implementation). Otherwise, for a type having no @key, if the type is a root type (e.g., Query or Mutation), then each field can also only be in a single subgraph (e.g., same rule as for @key but a different way to identify the object type). Otherwise, for a type having no @key and is not a root type (e.g., value types), individual fields must be part of all the subgraphs in which the type is defined. Put another way, all definitions of the type must be identical in each subgraph. Identical across subgraphs means the subgraphs must be relatively highly consistent with each other (e.g., the same). These particular rules and/or permitted layouts may be relatively easy to understand and they do support and/or enforce the FPF. However, such rules and/or permitted layouts for the particular federated approach may be somewhat limiting, restrictive and/or inflexible, for example.

The particular federated approach discussed above requires a relatively higher degree of consistency for shared value types (e.g., all types had to be exactly the same across subgraphs). A further federated approach, such as discussed more fully below, introduces an eventually consistent model so value type changes (e.g., adding a field) may be made one subgraph at a time (e.g., using “@inaccessible” to hide a newly added field until it is added to each subgraph one at a time on their own release schedule) instead of forcing all subgraphs to do a joint release that may be difficult to schedule & coordinate. With the further federated approach and its eventually consistent model for shared value types, the further federated approach introduces new machine-readable composition hints generated during composition to show the subgraph divergence (inconsistencies) across graph types and/or fields definitions, so they may be observed and/or validated in the supergraph build pipeline with user-defined policies and/or build pipeline automation to validate and/or notify teams of potential issues. As such, the further federated approach may provide more flexibility (e.g., flexible type merging that supports eventually consistent types and/or field definitions across subgraphs and also more visibility and/or control via composition hints to effectively govern this additional flexibility).

As mentioned, a particular federated approach may allow a single subgraph to provide a Query root field that would be composed into the unified graph. Therefore, the query planner may always send the query for a given Query root field to the single and only subgraph that provided that Query root field in the unified graph and then may fetch additional fields from additional subgraphs using the “_entities” and/or “@key” to join in additional subgraph data. As discussed more fully below, a further federated approach may allow multiple subgraphs to provide the same Query root field and the further federated approach query planner may now be able to pick the most advantageous subgraph for the entry point of the query to minimize the number of subgraph fetches, for example.

For a further federated approach, such as an example approach discussed below, a number of object types and/or a number of layouts may be acceptable so long as they do not break the FPF. This means that, in implementations, for one or more particular subgraphs composed into a particular supergraph schema, any layout for the one or more particular subgraphs may be specified to be acceptable as long as queries of interest (e.g., queries based on particular supergraph schema API) can be served from the particular subgraphs. For example, given an object type T, and given any query path to T (e.g., wherein “query path” refers to a chain of fields on the supergraph schema API that starts from a root field and ends on a field of type T or a super-type of T), and additionally given a field f of T on the supergraph API, there exists a “subgraph query path” (e.g., a query plan) to fetch f.

Because for any particular supergraph schema there exists a finite number of types with a finite number of fields, and further because there exists a finite number of query paths (e.g., assuming cycles are broken), validating a particular supergraph schema under the further approach discussed below to ensure adherence to FPF may be computationally feasible.

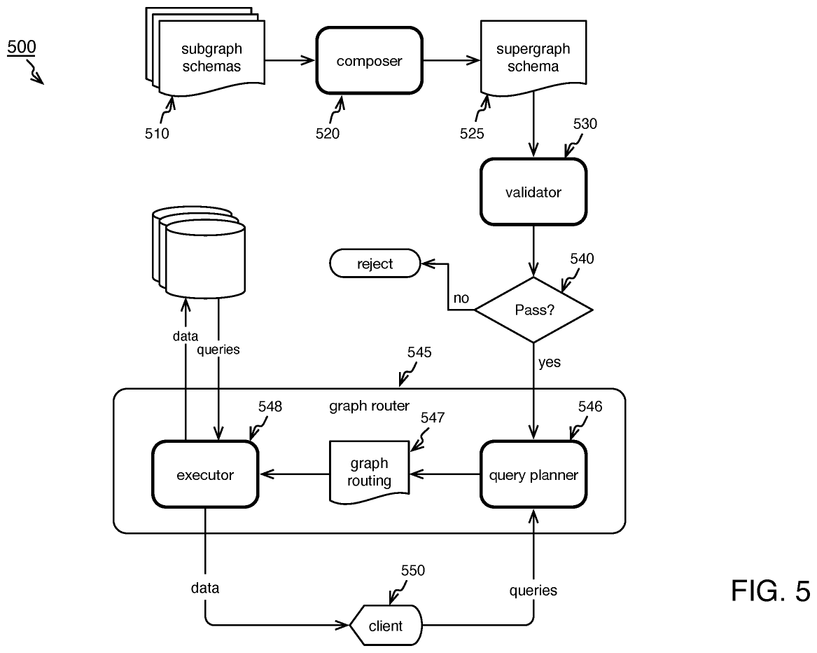

For a further approach for federated graph utilization, such as depicted in FIG. 5, for example, composition rules, guidelines, etc. may be more relatively simple and/or relaxed (e.g., more flexible type merging, more flexible composition rules, etc.) so that composition can succeed in more scenarios and/or to allow for improved schema evolution in multi-team environments, for example. In implementations, a further approach for federated graph utilization may include a generalized composition model based, at least in part, on the FPF that may support smaller incremental changes, more flexible value type merging and/or an improved shared ownership model, for example, as explained more fully below. As also explained more fully herein, a generalized composition model in support of the FPF, with its more flexible value type merging, improved shared ownership model and/or deeper static analysis/validation, in combination with the utilization of declarative graph composition into a static structure (e.g., subgraph schemas composed into a supergraph schema), may provide a number of benefits and/or advantages over other approaches, such as schema stitching and/or other approaches that may be authored in a specific programming language such as Javascript, that may be dynamically evaluated at runtime and that may therefore be more prone to errors. The benefits and/or advantages of the further federated approach may include, for example, an ability to statically analyze a supergraph schema at build time to catch errors sooner, thereby enabling an ecosystem of supergraph tooling that may lint, validate, transform and/or otherwise process a supergraph schema in CI/CD pipelines and/or may send notifications and/or generate reports by which the correctness of a supergraph schema may be validated and/or ensured before it may be delivered to a fleet of graph routers processing client queries at scale, for example.

As mentioned, implementations (e.g., based at least in part on a further federated approach to graph utilization) may include declarative composition into a static artifact (e.g., composing subgraph schema into a supergraph schema) that may be statically analyzed at or near build time instead of just at runtime. Such implementations may allow development teams and/or groups of development teams in a company, for example, to further ensure correctness and/or safety of a composed supergraph at build time in an achievable and bounded way, for example. In contrast, with a schema stitching approach, it may be difficult and/or nearly impossible to validate schema stitching code because it is based on a general programming model instead of a more bounded declarative model that results in a single, statically analyzable federated GraphQL schema, for example.

FIG. 5 is an illustration depicting an embodiment 500 of a process demonstrating a further approach for federated graph utilization. Embodiments may include all of the operations, processes, techniques, approaches, etc. described, fewer than the operations, processes, techniques, approaches, etc. described, and/or more than the operations, processes, techniques, approaches, etc. described for example process 500. Likewise, it should be noted that content acquired or produced, such as, for example, input signals, output signals, operations, results, etc. associated with the example provided may be represented via one or more analog and/or digital signals and/or signal packets. It should also be appreciated that even though one or more operations, processes, techniques, approaches, etc. are illustrated or described concurrently or with respect to a certain sequence, other sequences or concurrent operations processes, techniques, approaches, etc. may be employed. Further, it should be noted that operations, processes, techniques, approaches, etc. may be implemented, performed, etc. by any combination of hardware, firmware and/or software. In addition, although the description below references particular aspects and/or features illustrated in certain other figures, one or more operations, processes, techniques, approaches, etc. may be performed with other aspects and/or features.

In an implementation, a composer process, such as composer 520, may obtain graph schemas, such as subgraph schemas 510, for one or more services and/or may generate a new unified graph schema, such as supergraph schema 525, that may join content from the individual subgraph schemas. Also, in an implementation, a validator process, such as validator process 530, may operate on supergraph schema 525 and/or may ensure that a graph routing exists for theoretically possible queries of interest (e.g., one or more theoretically possible queries, all theoretically possible queries, etc.) against supergraph schema 525. In other words, in an implementation, validator 530 may ensure that theoretically possible supergraph queries of interest can be satisfied by routing content (e.g., data) between queries against one or more subgraphs, for example. As depicted at block 540 of example process 500, supergraph schema 525 may be rejected should it fail validator process 530. As also indicated at block 540, should supergraph schema 525 pass validator process 530, supergraph schema 525 may be provided to a graph router process, such as graph router 545.

In implementations, a validator process, such as validator 530, may be optional. However, if an implementation lacks a validator process that operates at or near build-time, for example, a graph router process, such as graph router 545, may not discover that a query cannot be successfully routed until runtime, responsive to a query being obtained from a front-end application, for example. Such circumstances may result in user-facing errors. For an implementation with a validator process performed at or near build-time, for example, such errors may be discovered prior to deployment, thereby improving service reliability and/or improving user experiences. For example, changes to subgraphs may originate at individual developer's computing devices (e.g., laptops). In implementations, validator processes may be performed on the individual developer's computing devices and this allows validation of subgraph changes relatively very early in the development process.

Again, referring to example process 500, a graph router process, such as graph router process 545, may obtain a supergraph schema, such as supergraph schema 525. Graph router process 545 may accept queries from client computing devices, such as client computing devices 550, and/or may return results to client computing devices, for example. In implementations, graph router process 545 may include a query planner process, such as query planner process 546, and/or may include an executor process, such as executor process 548. In an implementation, query planner process 546 may obtain an incoming query from a client computing device 550 and/or may utilize knowledge of a supergraph schema, such as supergraph schema 525, to construct a graph routing, such as graph routing 547, which may comprise a data structure specifying a set of subgraph queries and/or describing a flow of content between subgraph queries so that content requested by a query can be correctly located, for example. Also, in an implementation, executor process 548 may obtain a routing, such as graph routing 547, and/or may execute the graph routing to perform subgraph queries and/or to route content between the queries.

Referring again to FIG. 5, composer process 520 may obtain subgraph schemas 510 and/or may generate supergraph schema 525 based at least in part on subgraph schemas 510, for example. In an implementation, a supergraph schema, such as supergraph schema 525, may have particular example characteristics and/or properties. For example, in an implementation, types within a supergraph schema, such as supergraph schema 525, may join one or more subgraph types. Further, for example, individual fields within a supergraph schema, such as supergraph schema 525, may refer to fields within one or more subgraphs, such as subgraphs 510. Also, in an implementation, a supergraph schema, such as supergraph schema 525, may define a “join graph” that may associate individual supergraph fields with one or more subgraph fields which can resolve the data. In an implementation, subgraph fields may return different types and/or may contain different scalar content than the supergraph type to which they are joined. Further, in an implementation, it may be the responsibility of a validator process, such as validator process 530 described below, to ensure that such type conversions are valid.

In an implementation, a composer process, such as composer 520, may apply a join policy to construct a supergraph schema, such as supergraph schema 525. A join policy may determine the shape of a join graph, for example. A join policy's format may be implementation-dependent and/or may generally depend on a particular encoding of a graph. For example, if an encoding gives names to types and/or fields, a join policy might attempt to join subgraph types that may have the same name, in an implementation.

In addition to the various federated approaches discussed above, it may be advantageous to discuss additional embodiments and/or implementations that may provide a range of benefits and/or advantages in a wide range of circumstances. For example, GraphQL may support what might be referred to as a more closed-world model where GraphQL schema and/or types may be local to a given GraphQL processor, for example. In circumstances, a GraphQL schema may not support transitive linking to remote graphs, for example, and/or may not support an ability to dynamically import and/or delegate portions of a client query to external processors for operations such as GraphQL query validation and/or GraphQL query execution.

Further, the federated approaches described above may be substantially directed to teams collaborating on a shared API. Individual subgraphs may contribute to an overall schema, and/or composition rules may help ensure potential conflicts are resolved in a consistent manner. These approaches work well when an organizational structure is in place to coordinate schema design between teams, with a system and/or platform offering appropriate workflows to support that coordination.

In embodiments, a new graph linking-type approach may support a more open-world model where an existing graph may transitively link to specific types in a remote graph so clients can browse and/or query an existing graph plus linked remote types, fields, subfields, and/or subtypes, (e.g., all remote types, fields, subfields, and/or subtypes) along with any additional transitive links to additional remote graphs, for example.

Federated-type approaches and graph linking-type approaches may be complimentary, in implementations. For example, graph linking may not be meant to replace hierarchical subgraph composition in a single supergraph. Rather, in implementations, graph linking-type approaches may add an ability to define peer-to-peer links between supergraphs on top of federated-type mechanisms. Further, for example, links between graphs may allow clients to access content (e.g., data) from multiple graphs by sending a single GraphQL query to a single API endpoint, such as a graph router, in implementations. As utilized herein, “graph linking” and/or the like refers to mechanisms, processes, apparatus, etc. to transitively link to specified types in one or more remote graphs (e.g., supergraphs) within a particular graph, such as a supergraph, for example.

In implementations, a graph router computing device, such as graph router 340 and/or 545, serving a single supergraph in addition to types from linked remote graphs, for example, may create a query plan (e.g., advantageous, optimized, etc.) to reduce (e.g., minimize) response latency and/or to satisfy a client query through API-side joins with some number of: 1) subgraph fetches as may be accomplished with federated approaches that may support API-side joins via an @key directive; 2) remote fetches to linked graphs; 3) remote supergraphs that may support API-side joins via @key or any remote GraphQL API that supports API-side joins via @key; 4) and/or one or more entity references (e.g., any entity reference) that may comprise an entity type, namespace, and/or key (or id) fields suitable for retrieving a previously registered GraphQL API endpoint from a schema registry that can then be used to introspect and/or query the remote GraphQL API.

In implementations, a point of coordination (e.g., primary point of coordination) for graph linking-type approaches may include entities, which may comprise GraphQL types with the ‘@key’ directive used for API-side joins, for example. As mentioned, “entity” and/or the like refers to an object type that can resolve its fields across multiple subgraphs. Individual subgraphs may contribute different fields to the entity and/or may be responsible for resolving fields that it contributes (e.g., only fields that it contributes). In implementations, an entity may be defined within a particular subgraph by assigning the particular @key and/or by defining the particular entity's reference resolver. An “entity reference” and/or the like (“eref”) may comprise a universal reference to an entity. An entity reference, for example, may describe an entity through its namespace, entity type and/or key fields. At least in part via an entity reference, a system may look up APIs responsible for serving the particular entity and/or APIs in a schema registry. Also, for example, an entity reference may comprise an additional entry point to a graph. In implementations, entities may be fetched as part of a subquery, for example. In other implementations, a graph (e.g., global graph) may be explored at least in part by entering an entity reference in a graph browser or web browser with support for resolving an entity reference, for example. Of course, subject matter is not limited in scope in these respects.

In implementations, an entity reference may be formed by adding a set of keys and/or values to a type reference, for example. An entity reference may include the following form: “@github:User#id=gschmidt” or “@mycorp.billing:Invoice#year=2018,week=12,day=3,serial=1234”, for example. Of course, subject matter is not limited in scope in these respects. For example, the order of keys may not be significant. In implementations, for an entity reference to be legal and/or valid, a key may correspond to a unique key constraint on the type. In some cases (e.g., relatively more simple cases) a key in an eref may map directly to a field on an object. In other cases (e.g., relatively more complex cases), a query fragment that defines a unique key constraint may use GraphQL's aliasing feature to map the components of the query fragment to arbitrary key names. Thus, for example, the unique key constraint declarations, which may be part of the schema, may be utilized to validate and/or correctly interpret erefs. In implementations, the type of individual keys in the eref may be determined by looking at the schema. Further, that type may determine how the value in the eref is parsed into a real GraphQL value, for example.

In implementations, graph linking-type approaches may support transitive linking to another @graph and/or using the namespace and/or schema of that graph in a schema registry. Graph linking-type approaches may also support adding fields that may return remote entities, such as, for example, author: github_User, and/or may support extending remote entities, such as adding posts: [Post] to github_User, in implementations.

Consider the following example:

```
extend schema @graph(name: “@github”)
type Post @key(fields: “id”) {
  id: ID!
  title: String!
  author: github_User
}
type github_User @key(fields: “id”) {
  id: ID! @shared
  posts: [Post]
}
```

Apart from the namespacing, the example above may remind one of subgraphs in a federated-type approach, such as discussed above. A difference may be that a graph linking-type approach may not merge in linked schemas. For a global-type graph, for example, avoiding merging in linked schemas may mean avoiding merging in the whole world, as might be the case in a federated-type approach, given an ability to link to and from anyone and/or anywhere else.

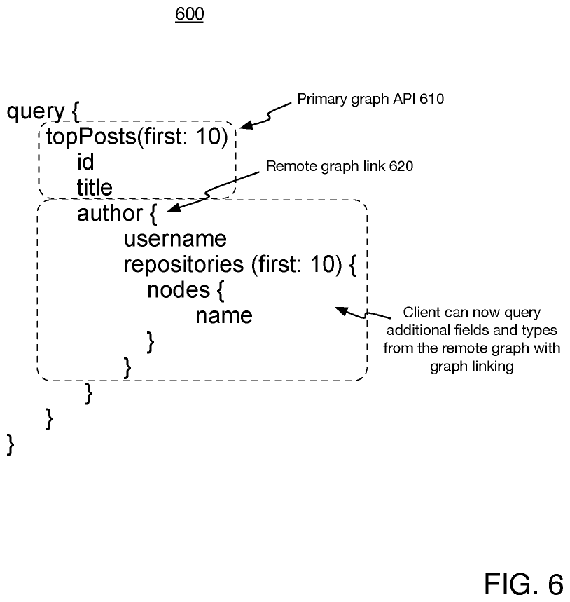

With such links in place, clients may be able to issue queries to a single GraphQL API for data that may be available for a particular type, including any relationships they would be able to follow when executing against the owning API for that remote type directly, for example. As such, an individual API (e.g., any single GraphQL API) may act as an entry point into a global graph, and, once a client is there, the client may be free to venture beyond just the local schema by following links, in implementations. Traversing those fields provides implicit access to other namespaces, which is how it may be possible to drill down into the GitHub API in the example of FIG. 6.

As depicted in FIG. 6, a query 600 may comprise references to an entity of a first (e.g., primary) graph API 610. Query 600 may further comprise a link 620 to a remote graph (e.g., “author” as depicted in FIG. 6). Via the “author” link, clients may query additional fields and/or types from the remote graph via graph linking, in implementations.

In implementations, in contrast to federation approaches which may compose all subgraphs in their entirety into a single large supergraph schema, a graph linking-type approach may establish a link between graphs that can be traversed at design-time and/or at runtime, for example. Further, graph linking-type approaches may add support for browsing and/or for accessing fields and/or associated types in a remote graph in addition to transitively linked types in additional remote graphs, for example. Additionally, in implementations, graph linking may be facilitated, at least in part, by a schema registry (e.g., GraphQL schema registry), where graphs (e.g., all graphs) may publish their schemas under a namespace that may be referenced in other graphs.

In implementations, support for a graph linking-type approach may prompt changes to a number of aspects of a graph routing platform. Such changes may include, by way of non-limiting examples, design-time browsing schemas for linked schemas plus query building, runtime validation of client queries where some parts of a query may be locally validated but linked types may be validated by separate GraphQL schemas, and/or runtime query execution may query plan and/or resolve fields present in the local schema, but may delegate query planning and/or execution of portions of a query that link to remote graphs, in implementations. Such changes may further include, for example, breaking change detection for schema changes in a remote graph, which may evaluate observed client operations (e.g., in the remote graph and/or graphs linking to it) to prevent impactful breaking changes from being made in a remote graph and/or to notify dependents when remote graphs have broken their observed usage, in implementations.

In various example embodiments and/or implementations, “graph linking” and/or the like may refer a mechanism that allows a graph (e.g., any graph) to refer to and/or extend types from other graphs, even if these graphs have no prior knowledge of each other, thereby giving clients a way (e.g., unified way) to formulate and/or execute queries that traverse fields across multiple APIs. In effect, graph linking-type approaches allow a set of all participating graphs to be treated as one virtual, global graph, for example.

In contrast to schema composition approaches, including schema stitching and/or federated-type approaches, graph linking-type approaches may not require queries to be defined against a single API, such as may be described by a pre-composed schema. Rather, for example, queries may select fields from multiple namespaces without concern for API boundaries, and it may be the responsibility of a graph linking-aware graph router to federate execution across APIs, in implementations.

From the perspective of graph linking, schema elements (e.g., all schema elements) may exist within a “namespace.” A graph may be defined with respect to a root namespace, meaning that unqualified schema elements implicitly belong to that particular namespace. In addition, however, graphs may contain explicit namespace declarations and/or may define schema elements to live within those namespaces, in implementations.

For the purposes of at least some examples described herein, graphs and/or namespaces may be thought of as orthogonal. In implementations, a centralized schema registry may keep track of mappings between namespaces and/or schema elements. Ownership and/or governance rules, as well as accompanying workflows, for example, may be defined to decide and/or enforce which parties are able to contribute schema elements to particular namespaces, for example. In a particular implementation, as a simplification, the implementation may rely on a 1:1 mapping between namespaces and supergraphs, although subject matter is not limited in scope in these respects.

In implementations, namespacing may apply to schema elements (e.g., all schema elements), not just top-level definitions. For example, a namespace of a field may not need to match the namespace of the type it is defined on. As a consequence, types may be extended with fields by anyone, not just the party defining the type (e.g., and/or other parties with rights to contribute to that type's namespace).

While standard GraphQL queries may be validated and/or executed against a single API schema, graph linking allows queries to specify selection sets that may reach into multiple namespaces, where schema elements may not all be served by the same API. In implementations, to facilitate graph linking at runtime during query execution, entity references that describe an entity through its namespace, entity type, and/or key (or id) fields, for example, may enable a system to lookup the APIs responsible for serving that entity and/or APIs in the schema registry and/or may enable the system to use the API endpoint for the linked graph as an entry point to fetch entities as part of a subquery, for example. Further, entity references may be used as an arbitrary entry point to the graph by using the entity reference in a graph browser that may allow one to explore a graph and/or transitively linked graphs to which it may be connected, for example. Implementations may provide a single integrated graph browsing experience able to provide an improved (e.g., optimized) developer experience for walking transitively linked graph schemas, building queries with fields from schemas in multiple namespaces, executing these queries, and/or analyzing the query plan across transitively linked graphs and the performance of such queries, for example.

In implementations, a query may still be statically analyzable, but interpretation may rely on a centralized schema registry to retrieve the applicable API schemas, for example. A result of an analysis phase may comprise an annotated query, for example, which may map individual field selections to one or more API schemas, in effect composing a query-specific schema on the fly, for example.

Further, for example, as a convenience for client developers, queries may use implicit namespacing, thereby avoiding a need to qualify each or individual field selection and/or type reference. To accomplish this, queries (e.g., each query, individual queries, etc.) may be defined with respect to a root namespace which may, in implementations, comprise a primary namespace associated with the supergraph the query is initially executed against. Selecting a field may change the implicit namespace to the namespace of the return type of that field, in an implementation. An incoming GraphQL query may therefore be normalized by assigning an explicit namespace to each field selection and/or type reference, for example. In implementations, this may occur in parallel with retrieving API schemas because the schemas are needed to lookup fields by name and/or to determine their return type. In implementations, once a query has been annotated, validation may proceed, for example. In implementations, graph routers may cache retrieved API schemas to improve (e.g., optimize) performance for query validation, query planning and/or query execution across transitively linked graphs.

During execution, a graph router, such a graph router 340 and/or 545, may choose to skip validation for parts of the query that are not part of the current supergraph schema, rather deferring validation to the respective GraphQL services responsible for individual parts, in implementations. Execution may include a query planning phase, similar in at least some respects to federated-type execution on a single supergraph, such as depicted in FIG. 5, for example. For graph linking-type approaches, however, a query plan may include fetches to other APIs for parts of the query that are not part of the current supergraph, in implementations.

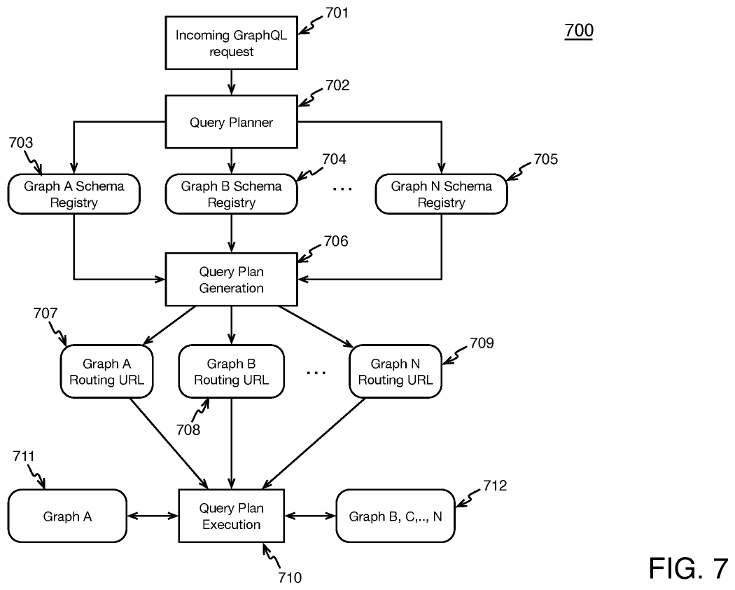

FIG. 7 is a schematic block diagram depicting an example process 700 for graph linking, in accordance with embodiments. For example process 700, a query may link multiple schemas, wherein the individual schemas may not know about each other, for example. Embodiments may include all of the operations, processes, techniques, approaches, etc. described, fewer than the operations, processes, techniques, approaches, etc. described, and/or more than the operations, processes, techniques, approaches, etc. described for example process 700. Likewise, it should be noted that content acquired or produced, such as, for example, input signals, output signals, operations, results, etc. associated with the example provided may be represented via one or more analog and/or digital signals and/or signal packets. It should also be appreciated that even though one or more operations, processes, techniques, approaches, etc. are illustrated or described concurrently or with respect to a certain sequence, other sequences or concurrent operations processes, techniques, approaches, etc. may be employed. Further, it should be noted that operations, processes, techniques, approaches, etc. may be implemented, performed, etc. by any combination of hardware, firmware and/or software. In addition, although the description below references particular aspects and/or features illustrated in certain other figures, one or more operations, processes, techniques, approaches, etc. may be performed with other aspects and/or features.

In implementations, an incoming GraphQL request may be received, as indicated at block 701. In implementations, the incoming GraphQL request may comprise a query including links (e.g., graph linking) to multiple graphs (e.g., graph A, graph B, . . . , graph N). A query planner (see block 702), such as graph router 340 and/or 545, for example, may obtain content from one or more schema registries (e.g., data structures), such as one or more schema registries pertaining to graphs A, B, . . . , N, as indicated at blocks 703, 704, and/or 705. In implementations, a graph router, such as graph router 340 and/or 545, may generate a query plan based at least in part on the content obtained from one or more schema registries (e.g., schema registries for graph A, graph B, . . . , graph N), as depicted at block 706. As indicated at blocks 707, 708, and/or 709, query plan generation may include generating plans to traverse the various graphs, for example. Based at least in part on the generated query plan, a graph router, such as graph router 340 and/or 545, for example, may execute the query plan at least in part by obtaining content from one or more data stores specified at least in part by the query plan, including data stores associated with graph A, graph B, . . . , graph N, as indicated at blocks 710, 711, and/or 712.

Of course, further details regarding the example operations depicted in example process 700 are discussed herein. For example, discussions herein may provide further detail related to query planning and/or query plan execution for graph linking-type approaches, in implementations.

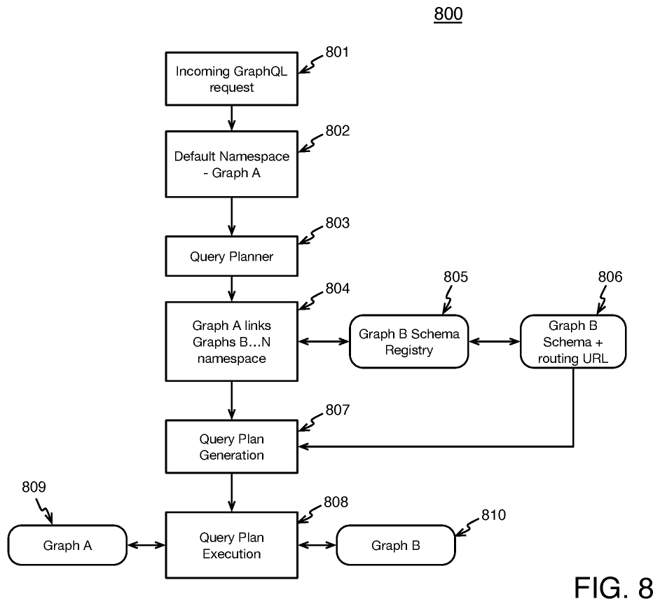

FIG. 8 is a schematic block diagram depicting an example device, system and/or process 800 for graph linking. For example device, system and/or process 800, the schema itself may be linked into other graphs. Embodiments may include all of the operations, processes, techniques, approaches, etc. described, fewer than the operations, processes, techniques, approaches, etc. described, and/or more than the operations, processes, techniques, approaches, etc. described for example process 800. Likewise, it should be noted that content acquired or produced, such as, for example, input signals, output signals, operations, results, etc. associated with the example provided may be represented via one or more analog and/or digital signals and/or signal packets. It should also be appreciated that even though one or more operations, processes, techniques, approaches, etc. are illustrated or described concurrently or with respect to a certain sequence, other sequences or concurrent operations processes, techniques, approaches, etc. may be employed. Further, it should be noted that operations, processes, techniques, approaches, etc. may be implemented, performed, etc. by any combination of hardware, firmware and/or software. In addition, although the description below references particular aspects and/or features illustrated in certain other figures, one or more operations, processes, techniques, approaches, etc. may be performed with other aspects and/or features.

In implementations, an incoming GraphQL request, for example, may be received, as indicated at block 801. As further indicated at block 802, an incoming GraphQL request, for example, may be defined, at least in part, with respect to a primary, default, and/or implicit namespace, in implementations. As mentioned, graph linking may be facilitated, at least in part, by a schema registry (e.g., GraphQL schema registry), where graphs (e.g., all graphs) may publish their schemas under a namespace that may be referenced in other graphs, for example.

As also mentioned, selecting a field may change an implicit namespace to the namespace of the return type of that field, in an implementation. Therefore, as part of a query planning process indicated at block 803, for example, an incoming GraphQL query, such as incoming GraphQL request 801, may be normalized by assigning explicit namespace to each field selection and/or type reference, for example. In implementations, this may occur in parallel with retrieving API schemas because the schemas are needed to lookup fields by name and/or to determine their return type. As indicated at blocks 804, 805, and/or 806, query planning may include traversing multiple links to multiple graph schema registries, wherein individual graphs may specify respective namespaces, for example. Although blocks 805 and 806 refer to a graph B, similar operations may be performed for any number of other linked graphs (e.g., graph C, . . . , graph N), for example.

As indicated at block 805, a query planner, such as graph router 340 and/or 545, may obtain types and/or schema content, for example, for the respective namespaces specified for graphs B, . . . , N, in implementations. Further, routing URLs pertaining to graphs B, . . . , N may also be obtained by graph router 340 and/or 545, for example, as indicated at block 806. Additionally, as indicated at block 807, a query plan may be generated based at least in part on content, including, for example, routing URL content, obtained from example operations depicted at blocks 804, 805, and/or 806.

Based at least in part on a query plan generated at block 807, for example, a graph router, such as graph router 340 and/or 545, for example, may execute the query plan at least in part by obtaining content from one or more data stores specified at least in part by the query plan, including data stores associated with graph A, graph B, . . . , graph N, as indicated at blocks 808, 809, and/or 810.

As discussed, graph linking, such as described in connection with example processes 700 and/or 800, for example, may enable queries to specify selection sets that reach into multiple namespaces, where schema elements may not all be served by the same API. Implementations may provide a single integrated graph browsing experience able to provide an improved (e.g., optimized) developer experience for walking transitively linked graph schemas, building queries with fields from schemas in multiple namespaces, executing these queries, and/or analyzing the query plan across transitively linked graphs and the performance of such queries, for example.

Although example devices, systems and/or processes 700 and/or 800 may mention particular graphs (e.g., graph A, graph B, . . . , graph N) implementations are not limited to any particular number of graphs. For example, implementations may include the involvement and/or utilization of any number of graphs (e.g., supergraphs, subgraphs, etc.). FIG. 7, for example, depicts possible graphs A, B, . . . , N intending to show that implementations may include any number of graphs. Also, FIG. 8 mentions graph A, graph B, . . . , graph N again intending to show that implementations may include any number of graphs.

In some implementations, when one supergraph links to another supergraph, each supergraph may have its own query planning and/or execution, such as depicted at blocks 706 and/or 710, and its own supergraph process, such as example process 700, as depicted in FIG. 7, with a link (e.g., recursive link) from query planning execution 710 to incoming GraphQL request 701, for example. It may also be noted that for graph linking security (e.g., to avoid a man-in-the-middle attack and/or the like) it may be advantageous to restrict passing of sensitive query context data (e.g., key field values, security headers, etc.) to a given linked graph to only what is needed to resolve its subquery in isolation (e.g., and not for other linked graphs). In this way, a primary supergraph router's job (e.g., the graph router receiving the client query) may be to orchestrate all linked graphs, and/or to be the sole trusted intermediary between all linked graphs to ensure communication across linked graphs remains unaltered and/or that sensitive query context data is not passed transitively across linked graphs, which could be used by a malicious linked graph to gain access to other graphs using a user's credentials, for example.

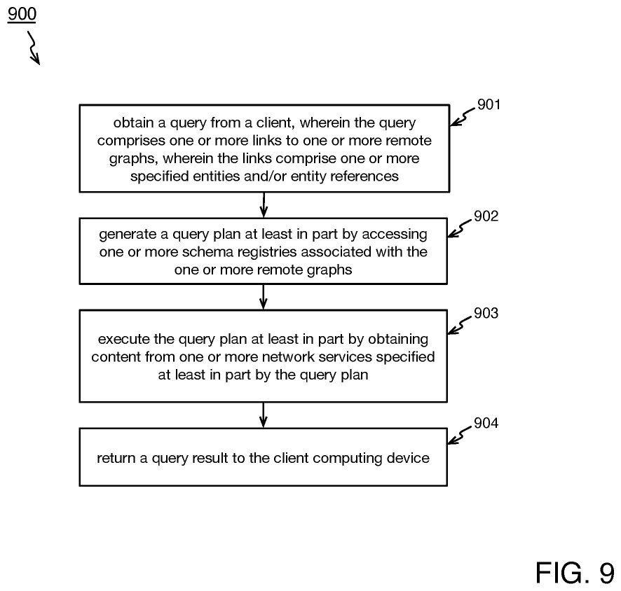

FIG. 9 is a flow diagram illustrating an example process, such as process 900, for graph linking, in accordance with example implementations and/or embodiments described herein. Embodiments may include all of the operations, processes, techniques, approaches, etc. described, fewer than the operations, processes, techniques, approaches, etc. described, and/or more than the operations, processes, techniques, approaches, etc. described for example process 900. Likewise, it should be noted that content acquired or produced, such as, for example, input signals, output signals, operations, results, etc. associated with the example provided may be represented via one or more analog and/or digital signals and/or signal packets. It should also be appreciated that even though one or more operations, processes, techniques, approaches, etc. are illustrated or described concurrently or with respect to a certain sequence, other sequences or concurrent operations processes, techniques, approaches, etc. may be employed. Further, it should be noted that operations, processes, techniques, approaches, etc. may be implemented, performed, etc. by any combination of hardware, firmware and/or software. In addition, although the description below references particular aspects and/or features illustrated in certain other figures, one or more operations, processes, techniques, approaches, etc. may be performed with other aspects and/or features.

As depicted in example 900, a graph router, such as graph router 340 and/or 545, may obtain a query from a client computing device, for example. See, for example, block 901 of FIG. 9. A query may comprise one or more links, implicit or otherwise, to one or more remote graphs, in implementations. Also, in implementations, links may comprise one or more specified entities or entity references. Further, for example, a graph router, such as graph router 340 and/or 545, may support transitive linking.

As also depicted in example 900, in implementations, a query plan may be generated at least in part by accessing one or more schema registries associated with the one or more remote graphs, as depicted at block 902. In implementations, the query plan may be executed at least in part by obtaining content from one or more network services specified at least in part by the query plan and a query result may be returned to the client computing device. See, for example, blocks 903 and/or 904 of FIG. 9.

As discussed above, federated approaches may build on GraphQL's advantages at least in part by working towards a powerful idea of being able to grab exactly the content (e.g., data) desired without developing special code to do so. Federated-type approaches discussed herein provide particular advantages in circumstances wherein the data desired may be spread out over multiple systems and/or managed by different teams, for example. Such federated-type approaches have given rise to an architecture referred to as the supergraph, discussed above. The supergraph provides a layer of the software/hardware stack that enables, at least in part, unification of all of one's content (e.g., data), services, and/or capabilities.

However, federated-type approaches may not be just about unifying one's particular data. Rather, federated-type approaches may involve providing access to specified content (e.g., all desired data), regardless of where the content resides or who is responsible for it. In many circumstances, more relatively modern applications may not be built on top of silos. Application data may increasingly need to go beyond a single API and/or beyond the boundaries of a single organization, for example.

There may exist a number of APIs that might help improve particular applications, and developers may wish to take advantage of such APIs. However, the effort involved in connecting such APIs to particular applications may often make this impractical. Thus, a significant amount of value may be left on the table, so to speak. For example, what features, apps, and/or companies, for example, are not being developed due to these challenges?

For example, consider a particular use case. For this example, it may be assumed that one wishes to develop a travel management app. What might an ideal developer experience for this app look like? In the spirit of GraphQL, it may be desirable to empower developers to write queries that specify solely the data they need and not where or how to get the data needed. For this particular travel management app example, one may want to show flight status related to a particular trip. A developer might write, for example:

```
query {
upcoming Trips {
    name
    flights {
      flightNumber
      airline {
        name
      }
      origin {
        name
      }
      destination {
        name
      }
      status {
        delayMinutes
        delayReason
      }
    }
  }
}
```

For the example above, what may be needed to make the query a reality? Well, one might add a subgraph that wraps access to a third-party API, for example. To do so, a developer might write some resolver agents, might fetch data from an endpoint, and/or might expose the data as part of a particular schema. Such solutions may work, but may be far from seamless. For example, the wrapping code may have to be written and maintained. This may consume significant resources, human and/or otherwise. For example, one may have to coordinate with another team and/or find room on the roadmap to develop such code. One may even decide that it isn't worth the effort.

The development process might be made somewhat easier by developing tooling that may autogenerate wrapping code and/or by developing a runtime software component that may operate based on a more declarative model. However, that may not remove the implementation and/or maintenance burden completely. For example, such an approach may not solve a more fundamental problem with wrapping.

When an external API is wrapped, it may become part of a particular schema. In effect, a part of another graph may be projected into an initial graph. One possible challenge with that approach is that it may lead to a close coupling between a particular schema and the data model of an API that may be outside of one's control. By bringing in external data, one may have taken on the responsibility for another API's data model. Any change to that underlying API may require a corresponding change not just to one's wrapping code but to one's schema, for example.

A related issue is that projection may significantly limit composability. Wrapping APIs may be a point-to-point solution, for example, that may prevent query planning improvements and/or optimizations. What may be needed is a more decoupled approach—an approach that may allow individual APIs to evolve independently and/or that empowers clients to take advantage of each API to the fullest without waiting for wrapping code to be written and/or updated.

To address such challenges, one may turn to the federated-type approaches discussed herein and/or the like. One aspect of such federated-type approaches is the idea that individual subgraphs may be responsible for just their respective parts of a supergraph. With such approaches, there may be a clear division of responsibility. For example, any subgraph may refer to a type and/or extend it with fields but the subgraph may not be responsible for anything that other subgraphs contribute. For the present travel management app example, consider the following:

type Query {
upcoming Trips: [Trip]
}
type Trip @key(fields: “id”) {
id: ID!
name: String
flights: [Flight]
}
type Flight @key(fields: “flightNumber”) {
flightNumber: String!
}

With at least some federated-type approaches, individual subgraphs may contribute types and/or fields to the same schema. Composition rules may help ensure that potential conflicts are detected and/or that such conflict can be resolved before deployment. This may work well in circumstances wherein the organizational structure is in place to coordinate schema design between teams. However, a truly global graph and/or the like may require a more loosely coupled architecture that may not depend on prior coordination.

To achieve, at least in part, a more relatively loosely coupled architecture that does not depend on prior coordination, graph linking-type approaches may be utilized. Of course, graph linking-type approaches, embodiments and/or implementations are discussed above. Applying a graph linking approach to the present travel management app example, consider the following:

```
@self (name: “tripplanner”)
@link (to: “airline”)
type Query {
  upcoming Trips: [Trip]
}
type Trip @key(fields: “id”) {
  id: ID!
  name: String
  flights: [airline_Flight]
}
type airline_Flight @key(fields: “flightNumber”) {
  flightNumber: String!
}
```

One aspect that may be noticed with the graph linking example provided above are some additional directives. From the perspective of a global graph, types and/or fields may exist within a namespace. Namespaces are discussed above, for example. It may also be noticed that the example shown above may resemble federated approaches gaining wider acceptance and/or utility. Also, for example, the query plan should look familiar.

As discussed previously, entities may comprise a building block of federated approaches. Among other things, entities may allow queries to hop from one graph to another. Further, for example, namespacing may allow one to define global entity references, or “Erefs.” Entity references, discussed previously, may comprise at least some aspects similar to those of URLs but instead of referencing a web page they may identify a shared object in a global graph, for example.

Namespacing may have another powerful feature and/or perhaps a bit of a surprising idea. Not only may types exist in a namespace, but so may fields. And, for example, a field's namespace may not have to match that of the type it is defined on, in implementations. For example, when someone extends an airline's flight type with carbon emissions for example, that field exists in the carbon namespace, not the airline namespace. It's that separation that may provide a relatively decoupled (e.g., fully decoupled) graph. Namespacing may allow anyone to extend a type without worrying about conflicts and/or without the need for prior coordination, for example.

In implementations, graph linking-type approaches may allow supergraphs to be treated as modules, just as subgraphs may be treated in federated-type approaches, for example. In implementations, supergraphs may exist independently but may also be connected in a principled way. Links between supergraphs may not result in pre-composed schemas, however. Instead, for example, a query may traverse API boundaries and/or a graph router may compose a dynamic schema on the fly. Again, subject matter related to these features are discussed above, at least in part.

In implementations, dynamic schemas may help provide for a truly global (e.g., wide ranging) graph. For circumstances in which there is a possibility for everything to be connected, static composition may not be practical. With static composition, one might end up with a single schema for the whole world (which, of course, may not be practical and/or possible). Instead, with graph linking-type approaches, the connections specified in a query may determine which graphs to be brought in.

In implementations, one may take this a step further because traversal may not be limited to the links that may be predefined in an API that one may be executing a query against. Consider this further travel management app example:

```
@link(to: “carbon”)
query {
upcoming Trips {
  name
  flights {
    flightNumber
    airline {
      name
    } origin
    destination
    carbon_emissions
  }
}
}
```

In implementations, anyone may add fields to any entity. Further, in implementations, queries may link to additional graphs to bring in these fields. This openness sits at the heart of at least some graph linking-type approaches discussed herein. With such approaches, there may be no need to coordinate with anyone when referring to and/or extending an entity, for example.

Graph linking-type approaches may provide a next step with respect to federated-type approaches. Graph linking-type approaches such as those discussed herein may build on a proven architecture but may also enable supergraphs to scale beyond a single organization, for example. One might even say graph linking approaches may provide a path to building one, global (e.g., wide ranging) supergraph.

In the context of the present patent application, the term “connection,” the term “component” and/or similar terms are intended to be physical but are not necessarily always tangible. Whether or not these terms refer to tangible subject matter, thus, may vary in a particular context of usage. As an example, a tangible connection and/or tangible connection path may be made, such as by a tangible, electrical connection, such as an electrically conductive path comprising metal or other conductor, that is able to conduct electrical current between two tangible components. Likewise, a tangible connection path may be at least partially affected and/or controlled, such that, as is typical, a tangible connection path may be open or closed, at times resulting from influence of one or more externally derived signals, such as external currents and/or voltages, such as for an electrical switch. Non-limiting illustrations of an electrical switch include a transistor, a diode, etc. However, a “connection” and/or “component,” in a particular context of usage, likewise, although physical, can also be non-tangible, such as a connection between a client and a server over a network, particularly a wireless network, which generally refers to the ability for the client and server to transmit, receive, and/or exchange communications, as discussed in more detail later.

In a particular context of usage, such as a particular context in which tangible components are being discussed, therefore, the terms “coupled” and “connected” are used in a manner so that the terms are not synonymous. Similar terms may also be used in a manner in which a similar intention is exhibited. Thus, “connected” is used to indicate that two or more tangible components and/or the like, for example, are tangibly in direct physical contact. Thus, using the previous example, two tangible components that are electrically connected are physically connected via a tangible electrical connection, as previously discussed. However, “coupled,” is used to mean that potentially two or more tangible components are tangibly in direct physical contact. Nonetheless, “coupled” is also used to mean that two or more tangible components and/or the like are not necessarily tangibly in direct physical contact, but are able to co-operate, liaise, and/or interact, such as, for example, by being “optically coupled.” Likewise, the term “coupled” is also understood to mean indirectly connected. It is further noted, in the context of the present patent application, since memory, such as a memory component and/or memory states, is intended to be non-transitory, the term physical, at least if used in relation to memory necessarily implies that such memory components and/or memory states, continuing with the example, are tangible.

Additionally, in the present patent application, in a particular context of usage, such as a situation in which tangible components (and/or similarly, tangible materials) are being discussed, a distinction exists between being “on” and being “over.” As an example, deposition of a substance “on” a substrate refers to a deposition involving direct physical and tangible contact without an intermediary, such as an intermediary substance, between the substance deposited and the substrate in this latter example; nonetheless, deposition “over” a substrate, while understood to potentially include deposition “on” a substrate (since being “on” may also accurately be described as being “over”), is understood to include a situation in which one or more intermediaries, such as one or more intermediary substances, are present between the substance deposited and the substrate so that the substance deposited is not necessarily in direct physical and tangible contact with the substrate.

A similar distinction is made in an appropriate particular context of usage, such as in which tangible materials and/or tangible components are discussed, between being “beneath” and being “under.” While “beneath,” in such a particular context of usage, is intended to necessarily imply physical and tangible contact (similar to “on,” as just described), “under” potentially includes a situation in which there is direct physical and tangible contact, but does not necessarily imply direct physical and tangible contact, such as if one or more intermediaries, such as one or more intermediary substances, are present. Thus, “on” is understood to mean “immediately over” and “beneath” is understood to mean “immediately under.”

It is likewise appreciated that terms such as “over” and “under” are understood in a similar manner as the terms “up,” “down,” “top,” “bottom,” and so on, previously mentioned. These terms may be used to facilitate discussion, but are not intended to necessarily restrict scope of claimed subject matter. For example, the term “over,” as an example, is not meant to suggest that claim scope is limited to only situations in which an embodiment is right side up, such as in comparison with the embodiment being upside down, for example. An example includes a flip chip, as one illustration, in which, for example, orientation at various times (e.g., during fabrication) may not necessarily correspond to orientation of a final product. Thus, if an object, as an example, is within applicable claim scope in a particular orientation, such as upside down, as one example, likewise, it is intended that the latter also be interpreted to be included within applicable claim scope in another orientation, such as right side up, again, as an example, and vice-versa, even if applicable literal claim language has the potential to be interpreted otherwise. Of course, again, as always has been the case in the specification of a patent application, particular context of description and/or usage provides helpful guidance regarding reasonable inferences to be drawn.

Unless otherwise indicated, in the context of the present patent application, the term “or” if used to associate a list, such as A, B, or C, is intended to mean A, B, and C, here used in the inclusive sense, as well as A, B, or C, here used in the exclusive sense. With this understanding, “and” is used in the inclusive sense and intended to mean A, B, and C; whereas “and/or” can be used in an abundance of caution to make clear that all of the foregoing meanings are intended, although such usage is not required. In addition, the term “one or more” and/or similar terms is used to describe any feature, structure, characteristic, and/or the like in the singular, “and/or” is also used to describe a plurality and/or some other combination of features, structures, characteristics, and/or the like. Likewise, the term “based on” and/or similar terms are understood as not necessarily intending to convey an exhaustive list of factors, but to allow for existence of additional factors not necessarily expressly described.

Furthermore, it is intended, for a situation that relates to implementation of claimed subject matter and is subject to testing, measurement, and/or specification regarding degree, that the particular situation be understood in the following manner. As an example, in a given situation, assume a value of a physical property is to be measured. If alternatively reasonable approaches to testing, measurement, and/or specification regarding degree, at least with respect to the property, continuing with the example, is reasonably likely to occur to one of ordinary skill, at least for implementation purposes, claimed subject matter is intended to cover those alternatively reasonable approaches unless otherwise expressly indicated. As an example, if a plot of measurements over a region is produced and implementation of claimed subject matter refers to employing a measurement of slope over the region, but a variety of reasonable and alternative techniques to estimate the slope over that region exist, claimed subject matter is intended to cover those reasonable alternative techniques unless otherwise expressly indicated.

To the extent claimed subject matter is related to one or more particular measurements, such as with regard to physical manifestations capable of being measured physically, such as, without limit, temperature, pressure, voltage, current, electromagnetic radiation, etc., it is believed that claimed subject matter does not fall within the abstract idea judicial exception to statutory subject matter. Rather, it is asserted, that physical measurements are not mental steps and, likewise, are not abstract ideas.

It is noted, nonetheless, that a typical measurement model employed is that one or more measurements may respectively comprise a sum of at least two components. Thus, for a given measurement, for example, one component may comprise a deterministic component, which in an ideal sense, may comprise a physical value (e.g., sought via one or more measurements), often in the form of one or more signals, signal samples and/or states, and one component may comprise a random component, which may have a variety of sources that may be challenging to quantify. At times, for example, lack of measurement precision may affect a given measurement. Thus, for claimed subject matter, a statistical or stochastic model may be used in addition to a deterministic model as an approach to identification and/or prediction regarding one or more measurement values that may relate to claimed subject matter.

For example, a relatively large number of measurements may be collected to better estimate a deterministic component. Likewise, if measurements vary, which may typically occur, it may be that some portion of a variance may be explained as a deterministic component, while some portion of a variance may be explained as a random component. Typically, it is desirable to have stochastic variance associated with measurements be relatively small, if feasible. That is, typically, it may be preferable to be able to account for a reasonable portion of measurement variation in a deterministic manner, rather than a stochastic matter as an aid to identification and/or predictability.

Along these lines, a variety of techniques have come into use so that one or more measurements may be processed to better estimate an underlying deterministic component, as well as to estimate potentially random components. These techniques, of course, may vary with details surrounding a given situation. Typically, however, more complex problems may involve use of more complex techniques. In this regard, as alluded to above, one or more measurements of physical manifestations may be modelled deterministically and/or stochastically. Employing a model permits collected measurements to potentially be identified and/or processed, and/or potentially permits estimation and/or prediction of an underlying deterministic component, for example, with respect to later measurements to be taken. A given estimate may not be a perfect estimate; however, in general, it is expected that on average one or more estimates may better reflect an underlying deterministic component, for example, if random components that may be included in one or more obtained measurements, are considered. Practically speaking, of course, it is desirable to be able to generate, such as through estimation approaches, a physically meaningful model of processes affecting measurements to be taken.

In some situations, however, as indicated, potential influences may be complex. Therefore, seeking to understand appropriate factors to consider may be particularly challenging. In such situations, it is, therefore, not unusual to employ heuristics with respect to generating one or more estimates. Heuristics refers to use of experience related approaches that may reflect realized processes and/or realized results, such as with respect to use of historical measurements, for example. Heuristics, for example, may be employed in situations where more analytical approaches may be overly complex and/or nearly intractable. Thus, regarding claimed subject matter, an innovative feature may include, in an example embodiment, heuristics that may be employed, for example, to estimate and/or predict one or more measurements.

It is further noted that the terms “type” and/or “like,” if used, such as with a feature, structure, characteristic, and/or the like, using “optical” or “electrical” as simple examples, means at least partially of and/or relating to the feature, structure, characteristic, and/or the like in such a way that presence of minor variations, even variations that might otherwise not be considered fully consistent with the feature, structure, characteristic, and/or the like, do not in general prevent the feature, structure, characteristic, and/or the like from being of a “type” and/or being “like,” (such as being an “optical-type” or being “optical-like,” for example) if the minor variations are sufficiently minor so that the feature, structure, characteristic, and/or the like would still be considered to be substantially present with such variations also present. Thus, continuing with this example, the terms optical-type and/or optical-like properties are necessarily intended to include optical properties. Likewise, the terms electrical-type and/or electrical-like properties, as another example, are necessarily intended to include electrical properties. It should be noted that the specification of the present patent application merely provides one or more illustrative examples and claimed subject matter is intended to not be limited to one or more illustrative examples; however, again, as has always been the case with respect to the specification of a patent application, particular context of description and/or usage provides helpful guidance regarding reasonable inferences to be drawn.

With advances in technology, it has become more typical to employ distributed computing and/or communication approaches in which portions of a process, such as signal processing of signal samples, for example, may be allocated among various devices, including one or more client devices and/or one or more server devices, via a computing and/or communications network, for example. A network may comprise two or more devices, such as network devices and/or computing devices, and/or may couple devices, such as network devices and/or computing devices, so that signal communications, such as in the form of signal packets and/or signal frames (e.g., comprising one or more signal samples), for example, may be exchanged, such as between a server device and/or a client device, as well as other types of devices, including between wired and/or wireless devices coupled via a wired and/or wireless network, for example.

An example of a distributed computing system comprises the so-called Hadoop distributed computing system, which employs a map-reduce type of architecture. In the context of the present patent application, the terms map-reduce architecture and/or similar terms are intended to refer to a distributed computing system implementation and/or embodiment for processing and/or for generating larger sets of signal samples employing map and/or reduce operations for a parallel, distributed process performed over a network of devices. A map operation and/or similar terms refer to processing of signals (e.g., signal samples) to generate one or more key-value pairs and to distribute the one or more pairs to one or more devices of the system (e.g., network). A reduce operation and/or similar terms refer to processing of signals (e.g., signal samples) via a summary operation (e.g., such as counting the number of students in a queue, yielding name frequencies, etc.). A system may employ such an architecture, such as by marshaling distributed server devices, executing various tasks in parallel, and/or managing communications, such as signal transfers, between various parts of the system (e.g., network), in an embodiment. As mentioned, one non-limiting, but well-known, example comprises the Hadoop distributed computing system. It refers to an open source implementation and/or embodiment of a map-reduce type architecture (available from the Apache Software Foundation, 1901 Munsey Drive, Forrest Hill, MD, 21050-2747), but may include other aspects, such as the Hadoop distributed file system (HDFS) (available from the Apache Software Foundation, 1901 Munsey Drive, Forrest Hill, MD, 21050-2747). In general, therefore, “Hadoop” and/or similar terms (e.g., “Hadoop-type,” etc.) refer to an implementation and/or embodiment of a scheduler for executing larger processing jobs using a map-reduce architecture over a distributed system. Furthermore, in the context of the present patent application, use of the term “Hadoop” is intended to include versions, presently known and/or to be later developed.

In the context of the present patent application, the term network device refers to any device capable of communicating via and/or as part of a network and may comprise a computing device. While network devices may be capable of communicating signals (e.g., signal packets and/or frames), such as via a wired and/or wireless network, they may also be capable of performing operations associated with a computing device, such as arithmetic and/or logic operations, processing and/or storing operations (e.g., storing signal samples), such as in memory as tangible, physical memory states, and/or may, for example, operate as a server device and/or a client device in various embodiments. Network devices capable of operating as a server device, a client device and/or otherwise, may include, as examples, dedicated rack-mounted servers, desktop computers, laptop computers, set top boxes, tablets, netbooks, smart phones, wearable devices, integrated devices combining two or more features of the foregoing devices, and/or the like, or any combination thereof. As mentioned, signal packets and/or frames, for example, may be exchanged, such as between a server device and/or a client device, as well as other types of devices, including between wired and/or wireless devices coupled via a wired and/or wireless network, for example, or any combination thereof. It is noted that the terms, server, server device, server computing device, server computing platform and/or similar terms are used interchangeably. Similarly, the terms client, client device, client computing device, client computing platform and/or similar terms are also used interchangeably. While in some instances, for ease of description, these terms may be used in the singular, such as by referring to a “client device” or a “server device,” the description is intended to encompass one or more client devices and/or one or more server devices, as appropriate. Along similar lines, references to a “database” are understood to mean, one or more databases and/or portions thereof, as appropriate.

It should be understood that for ease of description, a network device (also referred to as a networking device) may be embodied and/or described in terms of a computing device and vice-versa. However, it should further be understood that this description should in no way be construed so that claimed subject matter is limited to one embodiment, such as only a computing device and/or only a network device, but, instead, may be embodied as a variety of devices or combinations thereof, including, for example, one or more illustrative examples.

A network may also include now known, and/or to be later developed arrangements, derivatives, and/or improvements, including, for example, past, present and/or future mass storage, such as network attached storage (NAS), a storage area network (SAN), and/or other forms of device readable media, for example. A network may include a portion of the Internet, one or more local area networks (LANs), one or more wide area networks (WANs), wire-line type connections, wireless type connections, other connections, or any combination thereof. Thus, a network may be worldwide in scope and/or extent. Likewise, sub-networks, such as may employ differing architectures and/or may be substantially compliant and/or substantially compatible with differing protocols, such as network computing and/or communications protocols (e.g., network protocols), may interoperate within a larger network.

In the context of the present patent application, the term sub-network and/or similar terms, if used, for example, with respect to a network, refers to the network and/or a part thereof. Sub-networks may also comprise links, such as physical links, connecting and/or coupling nodes, so as to be capable to communicate signal packets and/or frames between devices of particular nodes, including via wired links, wireless links, or combinations thereof. Various types of devices, such as network devices and/or computing devices, may be made available so that device interoperability is enabled and/or, in at least some instances, may be transparent. In the context of the present patent application, the term “transparent,” if used with respect to devices of a network, refers to devices communicating via the network in which the devices are able to communicate via one or more intermediate devices, such as one or more intermediate nodes, but without the communicating devices necessarily specifying the one or more intermediate nodes and/or the one or more intermediate devices of the one or more intermediate nodes and/or, thus, may include within the network the devices communicating via the one or more intermediate nodes and/or the one or more intermediate devices of the one or more intermediate nodes, but may engage in signal communications as if such intermediate nodes and/or intermediate devices are not necessarily involved. For example, a graph router may provide a link and/or connection between otherwise separate and/or independent LANs.

In the context of the present patent application, a “private network” refers to a particular, limited set of devices, such as network devices and/or computing devices, able to communicate with other devices, such as network devices and/or computing devices, in the particular, limited set, such as via signal packet and/or signal frame communications, for example, without a need for re-routing and/or redirecting signal communications. A private network may comprise a stand-alone network; however, a private network may also comprise a subset of a larger network, such as, for example, without limitation, all or a portion of the Internet. Thus, for example, a private network “in the cloud” may refer to a private network that comprises a subset of the Internet. Although signal packet and/or frame communications (e.g. signal communications) may employ intermediate devices of intermediate nodes to exchange signal packets and/or signal frames, those intermediate devices may not necessarily be included in the private network by not being a source or designated destination for one or more signal packets and/or signal frames, for example. It is understood in the context of the present patent application that a private network may direct outgoing signal communications to devices not in the private network, but devices outside the private network may not necessarily be able to direct inbound signal communications to devices included in the private network.

The Internet refers to a decentralized global network of interoperable networks that comply with the Internet Protocol (IP). It is noted that there are several versions of the Internet Protocol. The term Internet Protocol, IP, and/or similar terms are intended to refer to any version, now known and/or to be later developed. The Internet includes local area networks (LANs), wide area networks (WANs), wireless networks, and/or long haul public networks that, for example, may allow signal packets and/or frames to be communicated between LANs. The term World Wide Web (WWW or Web) and/or similar terms may also be used, although it refers to a part of the Internet that complies with the Hypertext Transfer Protocol (HTTP). For example, network devices may engage in an HTTP session through an exchange of appropriately substantially compatible and/or substantially compliant signal packets and/or frames. It is noted that there are several versions of the Hypertext Transfer Protocol. The term Hypertext Transfer Protocol, HTTP, and/or similar terms are intended to refer to any version, now known and/or to be later developed. It is likewise noted that in various places in this document substitution of the term Internet with the term World Wide Web (“Web”) may be made without a significant departure in meaning and may, therefore, also be understood in that manner if the statement would remain correct with such a substitution.

Although claimed subject matter is not in particular limited in scope to the Internet and/or to the Web; nonetheless, the Internet and/or the Web may without limitation provide a useful example of an embodiment at least for purposes of illustration. As indicated, the Internet and/or the Web may comprise a worldwide system of interoperable networks, including interoperable devices within those networks. The Internet and/or Web has evolved to a public, self-sustaining facility accessible to potentially billions of people or more worldwide. Also, in an embodiment, and as mentioned above, the terms “WWW” and/or “Web” refer to a part of the Internet that complies with the Hypertext Transfer Protocol. The Internet and/or the Web, therefore, in the context of the present patent application, may comprise a service that organizes stored digital content, such as, for example, text, images, video, etc., through the use of hypermedia, for example. It is noted that a network, such as the Internet and/or Web, may be employed to store electronic files and/or electronic documents.

The term electronic file and/or the term electronic document are used throughout this document to refer to a set of stored memory states and/or a set of physical signals associated in a manner so as to thereby at least logically form a file (e.g., electronic) and/or an electronic document. That is, it is not meant to implicitly reference a particular syntax, format and/or approach used, for example, with respect to a set of associated memory states and/or a set of associated physical signals. If a particular type of file storage format and/or syntax, for example, is intended, it is referenced expressly. It is further noted an association of memory states, for example, may be in a logical sense and not necessarily in a tangible, physical sense. Thus, although signal and/or state components of a file and/or an electronic document, for example, are to be associated logically, storage thereof, for example, may reside in one or more different places in a tangible, physical memory, in an embodiment.

A Hyper Text Markup Language (“HTML”), for example, may be utilized to specify digital content and/or to specify a format thereof, such as in the form of an electronic file and/or an electronic document, such as a Web page, Web site, etc., for example. An Extensible Markup Language (“XML”) may also be utilized to specify digital content and/or to specify a format thereof, such as in the form of an electronic file and/or an electronic document, such as a Web page, Web site, etc., in an embodiment. Of course, HTML and/or XML are merely examples of “markup” languages, provided as non-limiting illustrations. Furthermore, HTML and/or XML are intended to refer to any version, now known and/or to be later developed, of these languages. Likewise, claimed subject matter are not intended to be limited to examples provided as illustrations, of course.

In the context of the present patent application, the term “Web site” and/or similar terms refer to Web pages that are associated electronically to form a particular collection thereof. Also, in the context of the present patent application, “Web page” and/or similar terms refer to an electronic file and/or an electronic document accessible via a network, including by specifying a uniform resource locator (URL) for accessibility via the Web, in an example embodiment. As alluded to above, in one or more embodiments, a Web page may comprise digital content coded (e.g., via computer instructions) using one or more languages, such as, for example, markup languages, including HTML and/or XML, although claimed subject matter is not limited in scope in this respect. Also, in one or more embodiments, application developers may write code (e.g., computer instructions) in the form of JavaScript (or other programming languages), for example, executable by a computing device to provide digital content to populate an electronic document and/or an electronic file in an appropriate format, such as for use in a particular application, for example. Use of the term “JavaScript” and/or similar terms intended to refer to one or more particular programming languages are intended to refer to any version of the one or more programming languages identified, now known and/or to be later developed. Thus, JavaScript is merely an example programming language. As was mentioned, claimed subject matter is not intended to be limited to examples and/or illustrations.

In the context of the present patent application, the terms “entry,” “electronic entry,” “document,” “electronic document,” “content”, “digital content,” “item,” and/or similar terms are meant to refer to signals and/or states in a physical format, such as a digital signal and/or digital state format, e.g., that may be perceived by a user if displayed, played, tactilely generated, etc. and/or otherwise executed by a device, such as a digital device, including, for example, a computing device, but otherwise might not necessarily be readily perceivable by humans (e.g., if in a digital format). Likewise, in the context of the present patent application, digital content provided to a user in a form so that the user is able to readily perceive the underlying content itself (e.g., content presented in a form consumable by a human, such as hearing audio, feeling tactile sensations and/or seeing images, as examples) is referred to, with respect to the user, as “consuming” digital content, “consumption” of digital content, “consumable” digital content and/or similar terms. For one or more embodiments, an electronic document and/or an electronic file may comprise a Web page of code (e.g., computer instructions) in a markup language executed or to be executed by a computing and/or networking device, for example. In another embodiment, an electronic document and/or electronic file may comprise a portion and/or a region of a Web page. However, claimed subject matter is not intended to be limited in these respects.

Also, for one or more embodiments, an electronic document and/or electronic file may comprise a number of components. As previously indicated, in the context of the present patent application, a component is physical, but is not necessarily tangible. As an example, components with reference to an electronic document and/or electronic file, in one or more embodiments, may comprise text, for example, in the form of physical signals and/or physical states (e.g., capable of being physically displayed). Typically, memory states, for example, comprise tangible components, whereas physical signals are not necessarily tangible, although signals may become (e.g., be made) tangible, such as if appearing on a tangible display, for example, as is not uncommon. Also, for one or more embodiments, components with reference to an electronic document and/or electronic file may comprise a graphical object, such as, for example, an image, such as a digital image, and/or sub-objects, including attributes thereof, which, again, comprise physical signals and/or physical states (e.g., capable of being tangibly displayed). In an embodiment, digital content may comprise, for example, text, images, audio, video, and/or other types of electronic documents and/or electronic files, including portions thereof, for example.

Also, in the context of the present patent application, the term parameters (e.g., one or more parameters) refer to material descriptive of a collection of signal samples, such as one or more electronic documents and/or electronic files, and exist in the form of physical signals and/or physical states, such as memory states. For example, one or more parameters, such as referring to an electronic document and/or an electronic file comprising an image, may include, as examples, time of day at which an image was captured, latitude and longitude of an image capture device, such as a camera, for example, etc. In another example, one or more parameters relevant to digital content, such as digital content comprising a technical article, as an example, may include one or more authors, for example. Claimed subject matter is intended to embrace meaningful, descriptive parameters in any format, so long as the one or more parameters comprise physical signals and/or states, which may include, as parameter examples, collection name (e.g., electronic file and/or electronic document identifier name), technique of creation, purpose of creation, time and date of creation, logical path if stored, coding formats (e.g., type of computer instructions, such as a markup language) and/or standards and/or specifications used so as to be protocol compliant (e.g., meaning substantially compliant and/or substantially compatible) for one or more uses, and so forth.

Signal packet communications and/or signal frame communications, also referred to as signal packet transmissions and/or signal frame transmissions (or merely “signal packets” or “signal frames”), may be communicated between nodes of a network, where a node may comprise one or more network devices and/or one or more computing devices, for example. As an illustrative example, but without limitation, a node may comprise one or more sites employing a local network address, such as in a local network address space. Likewise, a device, such as a network device and/or a computing device, may be associated with that node. It is also noted that in the context of this patent application, the term “transmission” is intended as another term for a type of signal communication that may occur in any one of a variety of situations. Thus, it is not intended to imply a particular directionality of communication and/or a particular initiating end of a communication path for the “transmission” communication. For example, the mere use of the term in and of itself is not intended, in the context of the present patent application, to have particular implications with respect to the one or more signals being communicated, such as, for example, whether the signals are being communicated “to” a particular device, whether the signals are being communicated “from” a particular device, and/or regarding which end of a communication path may be initiating communication, such as, for example, in a “push type” of signal transfer or in a “pull type” of signal transfer. In the context of the present patent application, push and/or pull type signal transfers are distinguished by which end of a communications path initiates signal transfer.

Thus, a signal packet and/or frame may, as an example, be communicated via a communication channel and/or a communication path, such as comprising a portion of the Internet and/or the Web, from a site via an access node coupled to the Internet or vice-versa. Likewise, a signal packet and/or frame may be forwarded via network nodes to a target site coupled to a local network, for example. A signal packet and/or frame communicated via the Internet and/or the Web, for example, may be routed via a path, such as either being “pushed” or “pulled,” comprising one or more routers, servers, etc. that may, for example, route a signal packet and/or frame, such as, for example, substantially in accordance with a target and/or destination address and availability of a network path of network nodes to the target and/or destination address. Although the Internet and/or the Web comprise a network of interoperable networks, not all of those interoperable networks are necessarily available and/or accessible to the public.

In the context of the particular patent application, a network protocol, such as for communicating between devices of a network, may be characterized, at least in part, substantially in accordance with a layered description, such as the so-called Open Systems Interconnection (OSI) seven layer type of approach and/or description. A network computing and/or communications protocol (also referred to as a network protocol) refers to a set of signaling conventions, such as for communication transmissions, for example, as may take place between and/or among devices in a network. In the context of the present patent application, the term “between” and/or similar terms are understood to include “among” if appropriate for the particular usage and vice-versa. Likewise, in the context of the present patent application, the terms “compatible with,” “comply with” and/or similar terms are understood to respectively include substantial compatibility and/or substantial compliance.

A network protocol, such as protocols characterized substantially in accordance with the aforementioned OSI description, has several layers. These layers are referred to as a network stack. Various types of communications (e.g., transmissions), such as network communications, may occur across various layers. A lowest level layer in a network stack, such as the so-called physical layer, may characterize how symbols (e.g., bits and/or bytes) are communicated as one or more signals (and/or signal samples) via a physical medium (e.g., twisted pair copper wire, coaxial cable, fiber optic cable, wireless air interface, combinations thereof, etc.). Progressing to higher-level layers in a network protocol stack, additional operations and/or features may be available via engaging in communications that are substantially compatible and/or substantially compliant with a particular network protocol at these higher-level layers. For example, higher-level layers of a network protocol may, for example, affect device permissions, user permissions, etc.

A network and/or sub-network, in an embodiment, may communicate via signal packets and/or signal frames, such as via participating digital devices and may be substantially compliant and/or substantially compatible with, but is not limited to, now known and/or to be developed, versions of any of the following network protocol stacks: ARCNET, AppleTalk, ATM, Bluetooth, DECnet, Ethernet, FDDI, Frame Relay, HIPPI, IEEE 1394, IEEE 802.11, IEEE-488, Internet Protocol Suite, IPX, Myrinet, OSI Protocol Suite, QsNet, RS-232, SPX, System Network Architecture, Token Ring, USB, and/or X.25. A network and/or sub-network may employ, for example, a version, now known and/or later to be developed, of the following: TCP/IP, UDP, DECnet, NetBEUI, IPX, AppleTalk and/or the like. Versions of the Internet Protocol (IP) may include IPv4, IPv6, and/or other later to be developed versions.

Regarding aspects related to a network, including a communications and/or computing network, a wireless network may couple devices, including client devices, with the network. A wireless network may employ stand-alone, ad-hoc networks, mesh networks, Wireless LAN (WLAN) networks, cellular networks, and/or the like. A wireless network may further include a system of terminals, gateways, routers, and/or the like coupled by wireless radio links, and/or the like, which may move freely, randomly and/or organize themselves arbitrarily, such that network topology may change, at times even rapidly. A wireless network may further employ a plurality of network access technologies, including a version of Long Term Evolution (LTE), WLAN, Wireless Router (WR) mesh, 2nd, 3rd, or 4th generation (2G, 3G, 4G, or 5G) cellular technology and/or the like, whether currently known and/or to be later developed. Network access technologies may enable wide area coverage for devices, such as computing devices and/or network devices, with varying degrees of mobility, for example.

A network may enable radio frequency and/or other wireless type communications via a wireless network access technology and/or air interface, such as Global System for Mobile communication (GSM), Universal Mobile Telecommunications System (UMTS), General Packet Radio Services (GPRS), Enhanced Data GSM Environment (EDGE), 3GPP Long Term Evolution (LTE), LTE Advanced, Wideband Code Division Multiple Access (WCDMA), Bluetooth, ultra-wideband (UWB), 802.11b/g/n, and/or the like. A wireless network may include virtually any type of now known and/or to be developed wireless communication mechanism and/or wireless communications protocol by which signals may be communicated between devices, between networks, within a network, and/or the like, including the foregoing, of course.

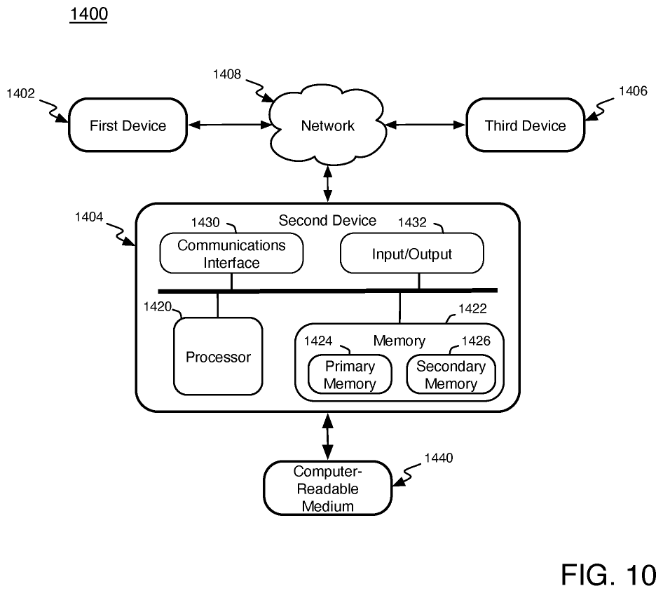

In one example embodiment, as shown in FIG. 10, a system embodiment may comprise a local network (e.g., device 1404 and medium 1440) and/or another type of network, such as a computing and/or communications network. For purposes of illustration, therefore, FIG. 10 shows an embodiment 1400 of a system that may be employed to implement either type or both types of networks. Network 1408 may comprise one or more network connections, links, processes, services, applications, and/or resources to facilitate and/or support communications, such as an exchange of communication signals, for example, between a computing device, such as 1402, and another computing device, such as 1406, which may, for example, comprise one or more client computing devices and/or one or more server computing device. By way of example, but not limitation, network 1408 may comprise wireless and/or wired communication links, telephone and/or telecommunications systems, Wi-Fi networks, Wi-MAX networks, the Internet, a local area network (LAN), a wide area network (WAN), or any combinations thereof.

Example devices in FIG. 10 may comprise features, for example, of a client computing device and/or a server computing device, in an embodiment. It is further noted that the term computing device, in general, whether employed as a client and/or as a server, or otherwise, refers at least to a processor and a memory connected by a communication bus. Likewise, in the context of the present patent application at least, this is understood to refer to sufficient structure within the meaning of 35 USC § 112 (f) so that it is specifically intended that 35 USC § 112 (f) not be implicated by use of the term “computing device” and/or similar terms; however, if it is determined, for some reason not immediately apparent, that the foregoing understanding cannot stand and that 35 USC § 112 (f), therefore, necessarily is implicated by the use of the term “computing device” and/or similar terms, then, it is intended, pursuant to that statutory section, that corresponding structure, material and/or acts for performing one or more functions be understood and be interpreted to be described at least in FIGS. 1-9 and in the text associated at least with the foregoing figure(s) of the present patent application.

Referring now to FIG. 10, in an embodiment, first and third devices 1402 and 1406 may be capable of rendering a graphical user interface (GUI) for a network device and/or a computing device, for example, so that a user-operator may engage in system use. Device 1404 may potentially serve a similar function in this illustration. Likewise, in FIG. 10, computing device 1402 (‘first device’ in figure) may interface with computing device 1404 (‘second device’ in figure), which may, for example, also comprise features of a client computing device and/or a server computing device, in an embodiment. Processor (e.g., processing device) 1420 and memory 1422, which may comprise primary memory 1424 and secondary memory 1426, may communicate by way of a communication bus 1415, for example. The term “computing device,” in the context of the present patent application, refers to a system and/or a device, such as a computing apparatus, that includes a capability to process (e.g., perform computations) and/or store digital content, such as electronic files, electronic documents, measurements, text, images, video, audio, sensor content, etc. in the form of signals and/or states. Thus, a computing device, in the context of the present patent application, may comprise hardware, software, firmware, or any combination thereof (other than software per se). Computing device 1404, as depicted in FIG. 10, is merely one example, and claimed subject matter is not limited in scope to this particular example.

For one or more embodiments, a device, such as a computing device and/or networking device, may comprise, for example, any of a wide range of digital electronic devices, including, but not limited to, desktop and/or notebook computers, high-definition televisions, digital versatile disc (DVD) and/or other optical disc players and/or recorders, game consoles, satellite television receivers, cellular telephones, tablet devices, wearable devices, personal digital assistants, mobile audio and/or video playback and/or recording devices, Internet of Things (IOT) type devices, endpoint and/or sensor nodes, gateways, router devices, or any combination of the foregoing. Further, unless specifically stated otherwise, a process as described, such as with reference to flow diagrams and/or otherwise, may also be executed and/or affected, in whole or in part, by a computing device and/or a network device. A device, such as a computing device and/or network device, may vary in terms of capabilities and/or features. Claimed subject matter is intended to cover a wide range of potential variations. For example, a device may include a numeric keypad and/or other display of limited functionality, such as a monochrome liquid crystal display (LCD) for displaying text, for example. In contrast, however, as another example, a web-enabled device may include a physical and/or a virtual keyboard, mass storage, one or more accelerometers, one or more gyroscopes, global positioning system (GPS) and/or other location-identifying type capability, and/or a display with a higher degree of functionality, such as a touch-sensitive color 2D or 3D display, for example.

As suggested previously, communications between a computing device and/or a network device and a wireless network may be in accordance with known and/or to be developed network protocols including, for example, global system for mobile communications (GSM), enhanced data rate for GSM evolution (EDGE), 802.11b/g/n/h, etc., and/or worldwide interoperability for microwave access (WiMAX). A computing device and/or a networking device may also have a subscriber identity module (SIM) card, which, for example, may comprise a detachable or embedded smart card that is able to store subscription content of a user, and/or is also able to store a contact list. It is noted, however, that a SIM card may also be electronic, meaning that is may simply be stored in a particular location in memory of the computing and/or networking device. A user may own the computing device and/or network device or may otherwise be a user, such as a primary user, for example. A device may be assigned an address by a wireless network operator, a wired network operator, and/or an Internet Service Provider (ISP). For example, an address may comprise a domestic or international telephone number, an Internet Protocol (IP) address, and/or one or more other identifiers. In other embodiments, a computing and/or communications network may be embodied as a wired network, wireless network, or any combinations thereof.

A computing and/or network device may include and/or may execute a variety of now known and/or to be developed operating systems, derivatives and/or versions thereof, including computer operating systems, such as Windows, iOS, Linux, a mobile operating system, such as iOS, Android, Windows Mobile, and/or the like. A computing device and/or network device may include and/or may execute a variety of possible applications, such as a client software application enabling communication with other devices. For example, one or more messages (e.g., content) may be communicated, such as via one or more protocols, now known and/or later to be developed, suitable for communication of email, short message service (SMS), and/or multimedia message service (MMS), including via a network, such as a social network, formed at least in part by a portion of a computing and/or communications network, including, but not limited to, Facebook, LinkedIn, Twitter, and/or Flickr, to provide only a few examples. A computing and/or network device may also include executable computer instructions to process and/or communicate digital content, such as, for example, textual content, digital multimedia content, sensor content, and/or the like. A computing and/or network device may also include executable computer instructions to perform a variety of possible tasks, such as browsing, searching, playing various forms of digital content, including locally stored and/or streamed video, and/or games such as, but not limited to, fantasy sports leagues. The foregoing is provided merely to illustrate that claimed subject matter is intended to include a wide range of possible features and/or capabilities.

In FIG. 10, computing device 1402 may provide one or more sources of executable computer instructions in the form physical states and/or signals (e.g., stored in memory states), for example. Computing device 1402 may communicate with computing device 1404 by way of a network connection, such as via network 1408, for example. As previously mentioned, a connection, while physical, may not necessarily be tangible. Although computing device 1404 of FIG. 10 shows various tangible, physical components, claimed subject matter is not limited to a computing devices having only these tangible components as other implementations and/or embodiments may include alternative arrangements that may comprise additional tangible components or fewer tangible components, for example, that function differently while achieving similar results. Rather, examples are provided merely as illustrations. It is not intended that claimed subject matter be limited in scope to illustrative examples.

Memory 1422 may comprise any non-transitory storage mechanism. Memory 1422 may comprise, for example, primary memory 1424 and secondary memory 1426, additional memory circuits, mechanisms, or combinations thereof may be used. Memory 1422 may comprise, for example, random access memory, read only memory, etc., such as in the form of one or more storage devices and/or systems, such as, for example, a disk drive including an optical disc drive, a tape drive, a solid-state memory drive, etc., just to name a few examples.

Memory 1422 may be utilized to store a program of executable computer instructions. For example, processor 1420 may fetch executable instructions from memory and proceed to execute the fetched instructions. Memory 1422 may also comprise a memory controller for accessing device readable-medium 1440 that may carry and/or make accessible digital content, which may include code, and/or instructions, for example, executable by processor 1420 and/or some other device, such as a controller, as one example, capable of executing computer instructions, for example. Under direction of processor 1420, a non-transitory memory, such as memory cells storing physical states (e.g., memory states), comprising, for example, a program of executable computer instructions, may be executed by processor 1420 and able to generate signals to be communicated via a network, for example, as previously described. Generated signals may also be stored in memory, also previously suggested.

Memory 1422 may store electronic files and/or electronic documents, such as relating to one or more users, and may also comprise a computer-readable medium that may carry and/or make accessible content, including code and/or instructions, for example, executable by processor 1420 and/or some other device, such as a controller, as one example, capable of executing computer instructions, for example. As previously mentioned, the term electronic file and/or the term electronic document are used throughout this document to refer to a set of stored memory states and/or a set of physical signals associated in a manner so as to thereby form an electronic file and/or an electronic document. That is, it is not meant to implicitly reference a particular syntax, format and/or approach used, for example, with respect to a set of associated memory states and/or a set of associated physical signals. It is further noted an association of memory states, for example, may be in a logical sense and not necessarily in a tangible, physical sense. Thus, although signal and/or state components of an electronic file and/or electronic document, are to be associated logically, storage thereof, for example, may reside in one or more different places in a tangible, physical memory, in an embodiment.

Algorithmic descriptions and/or symbolic representations are examples of techniques used by those of ordinary skill in the signal processing and/or related arts to convey the substance of their work to others skilled in the art. An algorithm is, in the context of the present patent application, and generally, is considered to be a self-consistent sequence of operations and/or similar signal processing leading to a desired result. In the context of the present patent application, operations and/or processing involve physical manipulation of physical quantities. Typically, although not necessarily, such quantities may take the form of electrical and/or magnetic signals and/or states capable of being stored, transferred, combined, compared, processed and/or otherwise manipulated, for example, as electronic signals and/or states making up components of various forms of digital content, such as signal measurements, text, images, video, audio, etc.

It has proven convenient at times, principally for reasons of common usage, to refer to such physical signals and/or physical states as bits, values, elements, parameters, symbols, characters, terms, numbers, numerals, measurements, content and/or the like. It should be understood, however, that all of these and/or similar terms are to be associated with appropriate physical quantities and are merely convenient labels. Unless specifically stated otherwise, as apparent from the preceding discussion, it is appreciated that throughout this specification discussions utilizing terms such as “processing,” “computing,” “calculating,” “determining”, “establishing”, “obtaining”, “identifying”, “selecting”, “generating”, and/or the like may refer to actions and/or processes of a specific apparatus, such as a special purpose computer and/or a similar special purpose computing and/or network device. In the context of this specification, therefore, a special purpose computer and/or a similar special purpose computing and/or network device is capable of processing, manipulating and/or transforming signals and/or states, typically in the form of physical electronic and/or magnetic quantities, within memories, registers, and/or other storage devices, processing devices, and/or display devices of the special purpose computer and/or similar special purpose computing and/or network device. In the context of this particular patent application, as mentioned, the term “specific apparatus” therefore includes a general purpose computing and/or network device, such as a general purpose computer, once it is programmed to perform particular functions, such as pursuant to program software instructions.

In some circumstances, operation of a memory device, such as a change in state from a binary one to a binary zero or vice-versa, for example, may comprise a transformation, such as a physical transformation. With particular types of memory devices, such a physical transformation may comprise a physical transformation of an article to a different state or thing. For example, but without limitation, for some types of memory devices, a change in state may involve an accumulation and/or storage of charge or a release of stored charge. Likewise, in other memory devices, a change of state may comprise a physical change, such as a transformation in magnetic orientation. Likewise, a physical change may comprise a transformation in molecular structure, such as from crystalline form to amorphous form or vice-versa. In still other memory devices, a change in physical state may involve quantum mechanical phenomena, such as, superposition, entanglement, and/or the like, which may involve quantum bits (qubits), for example. The foregoing is not intended to be an exhaustive list of all examples in which a change in state from a binary one to a binary zero or vice-versa in a memory device may comprise a transformation, such as a physical, but non-transitory, transformation. Rather, the foregoing is intended as illustrative examples.

Referring again to FIG. 10, processor 1420 may comprise one or more circuits, such as digital circuits, to perform at least a portion of a computing procedure and/or process. By way of example, but not limitation, processor 1420 may comprise one or more processors, such as controllers, microprocessors, microcontrollers, application specific integrated circuits, digital signal processors, programmable logic devices, field programmable gate arrays, the like, or any combination thereof. In various implementations and/or embodiments, processor 1420 may perform signal processing, typically substantially in accordance with fetched executable computer instructions, such as to manipulate signals and/or states, to construct signals and/or states, etc., with signals and/or states generated in such a manner to be communicated and/or stored in memory, for example.

FIG. 10 also illustrates device 1404 as including a component 1432 operable with input/output devices, for example, so that signals and/or states may be appropriately communicated between devices, such as device 1404 and an input device and/or device 1404 and an output device. A user may make use of an input device, such as a computer mouse, stylus, track ball, keyboard, and/or any other similar device capable of receiving user actions and/or motions as input signals. Likewise, for a device having speech to text capability, a user may speak to a device to generate input signals. A user may make use of an output device, such as a display, a printer, etc., and/or any other device capable of providing signals and/or generating stimuli for a user, such as visual stimuli, audio stimuli and/or other similar stimuli.

In the preceding description, various aspects of claimed subject matter have been described. For purposes of explanation, specifics, such as amounts, systems and/or configurations, as examples, were set forth. In other instances, well-known features were omitted and/or simplified so as not to obscure claimed subject matter. While certain features have been illustrated and/or described herein, many modifications, substitutions, changes and/or equivalents will now occur to those skilled in the art. It is, therefore, to be understood that the appended claims are intended to cover all modifications and/or changes as fall within claimed subject matter.

What is claimed is:

1. A method, comprising: at a graph router computing device: performing one or more graph linking operations including:
obtaining a query from a client computing device, wherein the query comprises one or more fields that in a GraphQL schema specifies one or more links to one or more remote graphs, wherein the one or more links to the one or more remote graphs comprise one or more specified entities and/or entity references;
generating a query plan at least in part by accessing one or more schema registries respectively associated with the one or more remote graphs;
executing the query plan at least in part by obtaining content from one or more network services specified at least in part by the query plan; and
returning a query result to the client computing device.

2. The method of claim 1, wherein the generating the query plan includes determining one or more APIs responsible for serving the one or more specified entities.

3. The method of claim 2, wherein the one or more specified entities comprise one or more GraphQL types having one or more @key directives.

4. The method of claim 1, wherein the one or more schema registries respectively associated with the one or more remote graphs contain schemas published to the schema registries under particular namespaces that are referenced in other graphs.

5. The method of claim 1, further comprising run-time validation of the obtained query wherein some parts of the query are locally validated and wherein one or more linked types are validated using separate GraphQL schemas.

6. The method of claim 5, wherein the generating the query plan and/or executing the query plan occurs at run-time, and wherein the generating the query plan and/or executing the query plan at runtime comprises query planning and/or resolving fields present in a local schema and further comprises delegating query planning and/or query execution of portions of the query to the linked one or more remote graphs.

7. The method of claim 6, wherein, to facilitate the performing, at runtime, the generating the query plan and/or the executing the query plan, the query to comprise one or more entity references that specify one or more respective entities via one or more respective namespaces, entity type and/or key (id) fields to enable the graph router computing device to lookup the one or more APIs responsible for serving the one or more specified entities.

8. The method of claim 1, wherein the generating the query plan includes selecting fields from multiple namespaces without concern for API boundaries, and wherein the one or more schema registries track mappings between namespaces and/or schema elements.

9. An apparatus comprising a graph router computing device, wherein, to perform one or more graph linking operations, the graph router computing device to:
obtain a query from a client computing device, wherein the query comprises one or more links to one or more remote graphs, wherein the one or more links to the one or more remote graphs comprise one or more specified entities and/or entity references;
generate a query plan at least in part by accessing one or more schema registries respectively associated with the one or more remote graphs;
execute the query plan at least in part by obtaining content from one or more network services specified at least in part by the query plan; and
return a query result to the client computing device.

10. The apparatus of claim 9, wherein, to generate the query plan, the graph router computing device to determine one or more APIs responsible for serving the one or more specified entities.

11. The apparatus of claim 10, wherein the one or more specified entities comprise one or more GraphQL types having one or more @key directives.

12. The apparatus of claim 9, wherein the one or more schema registries respectively associated with the one or more remote graphs contain schemas published to the schema registries under particular namespaces that are referenced in other graphs.

13. The apparatus of claim 9, wherein the graph router computing device further to perform run-time validation of the obtained query wherein some parts of the query are locally validated and wherein one or more linked types are validated using separate GraphQL schemas.

14. The apparatus of claim 13, wherein the graph router computing device to generate the query plan and/or execute the query plan at run-time, and wherein, to generate the query plan and/or to execute the query plan at runtime, the graph router computing device to perform query planning and/or to resolve fields present in a local schema and further to delegate query planning and/or query execution of portions of the query to the linked one or more remote graphs.

15. The apparatus of claim 14, wherein, to facilitate the performing, at runtime, generation of the query plan and/or execution of the query plan, the query to comprise one or more entity references that specify one or more respective entities via one or more respective namespaces, entity type and/or key (id) fields to enable the graph router computing device to lookup the one or more APIs responsible for serving the one or more specified entities.

16. The apparatus of claim 9, wherein, to generate the query plan, the graph router computing device to select fields from multiple namespaces without concern for API boundaries, and wherein the one or more schema registries track mappings between namespaces and/or schema elements.

17. An article, comprising: a storage medium having stored thereon instructions executable by a graph router computing device to: perform one or more graph linking operations, wherein the graph router to:
obtain a query from a client computing device, wherein the query comprises one or more links to one or more remote graphs, wherein the one or more links to the one or more remote graphs comprise one or more specified entities and/or entity references;
generate a query plan at least in part by accessing one or more schema registries respectively associated with the one or more remote graphs;
execute the query plan at least in part by obtaining content from one or more data stores specified at least in part by the query plan; and
return a query result to the client computing device.

18. The article of claim 17, wherein, to generate the query plan, the graph router computing device to determine one or more APIs responsible for serving the one or more specified entities.

19. The article of claim 18, wherein the one or more specified entities comprise one or more GraphQL types having one or more @key directives.

20. The article of claim 17, wherein the one or more schema registries respectively associated with the one or more remote graphs contain schemas published to the schema registries under particular namespaces that are referenced in other graphs.
